(19) United States
(12) Patent Application Publication
(10) Pub. No.: US 2024/0076532 A1
(43) Pub. Date: Mar. 7, 2024

(54) HOT MELT ADHESIVE COMPOSITION INCLUDING HIGH STYRENE CONTENT STYRENIC BLOCK COPOLYMER

(71) Applicant: H.B. Fuller Company, St. Paul, MN (US)

(72) Inventors: Thomas F. Kauffman, Bloomfield, CT (US); Daniel A. Everson, Lakeville, MN (US); Haiying zhou, Arden Hills, MN (US)

(21) Appl. No.: 18/547,581

(22) PCT Filed: Feb. 22, 2022
(86) PCT No.: PCT/US2022/070766

§ 371 Date: Aug. 23, 2023

Related U.S. Application Data
(60) Provisional application No. 63/152,557, filed on Feb. 23, 2021.
(60) Provisional application No. 63/152,574, filed on Feb. 23, 2021.
(60) Provisional application No. 63/203,041, filed on Jul. 6, 2021.
(60) Provisional application No. 63/203,043, filed on Jul. 6, 2021.

(51) Int. Cl. C09J 153/02

(52) U.S. Cl. CPC C09J 153/02

(57) ABSTRACT

A hot melt adhesive composition that includes a styrenic block copolymer that includes greater than 55% by weight styrene based on the weight of the styrenic block copolymer, at least 15% by weight plasticizer, and from 30% by weight to 70% by weight of a tackifying agent.

### BACKGROUND

The invention is directed to formulating hot melt adhesive compositions using a high styrene content styrenic block copolymer.

As the styrene content of a styrenic block copolymer increases, the rigidity of the polymer increases. Styrenic block copolymers having greater than 50% by weight styrene, for example, are relatively rigid, and are typically used to form self-supporting polymeric films. Such block copolymers had been viewed as too rigid to be suitable for use in hot melt adhesive compositions, pressure sensitive adhesive compositions, which often must have a storage modulus (G′) of less than 0.3 MPa. at 25° C., adhesives used in hygiene and bottle labeling applications, and adhesives for bonding difficult to bond substrates such as polyolefin

For an adhesive composition to be suitable for coating using existing hot melt applicators, the adhesive composition typically must exhibit a viscosity of less than 10,000 centipoise (cP), less than 5000 cP, or ideally less than 3000 cP at the application temperature. Currently there is a goal to coat hot melt adhesives at increasingly lower application temperatures, e.g., at 135° C., at 121° C., or even at 110° C. This goal is desired for a variety of reasons including decreasing energy consumption, improving worker health and safety ; and decreasing odor in the final article. There are also many applications that involve coating on temperature sensitive substrates such as polymer films used in applications as varied as tapes, labels, plastic bottle labeling, and disposable absorbent articles. It is desirable to coat adhesives on such substrates at a relatively low application temperatures to maintain the integrity of such temperature sensitive substrates. This is especially true as manufacturers seek to use thinner and thinner plastic films, which reduces plastic pollution and energy costs associated with shipping products. When hot melt adhesives are applied at very low application temperatures it is often difficult to achieve good adhesion to polymer films. In addition, hot melt adhesives coated at such low temperatures can exhibit undesirable properties such as a lack of hot tack, excessive flow at room temperature (also referred to as cold flow), during use, storage, or shipping, and lack of cohesive strength.

Plasticizers, such as oils, which have been used to both decrease the viscosity of adhesive compositions and soften adhesive compositions, can contribute to staining. Staining occurs when low molecular weight materials separate from an adhesive composition and soak into the substrate or onto the user of an article. Staining is undesirable from an aesthetic perspective and can result in bond performance deterioration.

There is a need for an alternative hot melt adhesive composition that exhibits good adhesion, can be applied at relatively low application temperatures, exhibits good adhesion to polymeric substrates, does not flow at the temperatures at which articles that are stored and transported in commerce would experience, and does not exhibit staining.

### SUMMARY

In one aspect, the invention features a hot melt adhesive composition that includes from 1.5% by weight to 25% by weight of a styrenic block copolymer that includes greater than 55% by weight styrene, at least 15% by weight plasticizer, and from 30% by weight to 70% by weight tackifying agent.

In one embodiment, the hot melt adhesive composition exhibits a glass transition temperature (Tg) of at least −10° C. In another embodiment the composition exhibits a Tg from 5° C. to 35° C. In some embodiments, the composition exhibits a Tg of at least −20° C. In other embodiments, the composition exhibits a Tg of at least 10° C.

In other embodiments, the composition exhibits a crossover temperature of greater than 80° C. and a viscosity of no greater than 5000 cP at 121° C. In one embodiment, the composition exhibits a crossover temperature of greater than 80° C. and a viscosity of no greater than 2000 cP at 121° C. in another embodiment, the composition exhibits a crossover temperature of greater than 80° C. and a viscosity of no greater than 1000 cP at 121° C.

In some embodiments, the composition exhibits a viscosity of no greater than 5000 cP at 121° C. In other embodiments, the composition exhibits a viscosity of no greater than 2000 cP at 121° C. In another embodiment, the composition exhibits a viscosity of no greater than 10000 cP at 163° C.

In another embodiment, the composition exhibits a peel adhesion of at least 0.6 N/cm when tested according to Peel Adhesion Test Method.

In one embodiment, the tackifying agent has a softening point greater than 90° C. In other embodiments, the tackifying agent has a softening point of at least 110° C. In some embodiments, the tackifying agent has a softening point of at least 120° C.

In other embodiments, the composition includes greater than 30% by weight plasticizer. In one embodiment, the composition includes at least 35% by weight plasticizer. In another embodiment, the composition includes at least 40% by weight plasticizer.

In some embodiments, the composition includes from 2% by weight to 15% by weight styrenic block copolymer that includes greater than 55% by weight styrene. In other embodiments, the composition includes from 2% by weight to 10% by weight of the styrenic block copolymer comprising greater than 55% by weight styrene. In another embodiment, the composition includes from 2% by weight to 8% by weight of the styrenic block copolymer comprising greater than 55% by weight styrene.

In one embodiment, the composition includes from 2% by weight to 15% by weight of a styrenic block copolymer that includes greater than 55% by weight styrene, from 35% by weight to 50% by weight of the plasticizer, and from 30% by weight to 60% by weight of a tackifying agent having a softening point of at least 120° C.

In another embodiment, the composition includes from 2% by weight to 10% by weight of a styrenic block copolymer that includes greater than 55% by weight styrene, from 35% by weight to 50% by weight of the plasticizer, and from 30% by weight to 60% by weight of a tackifying agent having a softening point of at least 120° C.

In some embodiments, the composition is free of staining.

In another aspect, the invention features a hot melt adhesive composition that includes from 1.5% by weight to 25% by weight of a hydrogenated styrenic block copolymer that includes greater than 55% by weight styrene, greater than 30% by weight of the plasticizer, and from 30% by weight to 60% by weight of the tackifying agent. In one embodiment, the composition exhibits a crossover temperature of greater than 85° C. and a viscosity no greater than 5000 cP at 121° C. In other embodiments, the composition exhibits a peel adhesion of at least 0.4 N/cm when tested according to Peel Adhesion Test Method. In other embodiments, the composition is free of staining, In still other embodiments, the tackifying agent has a softening point greater than 100° C. In another embodiment, the tackifying, agent has a softening point of at least 115° C., In other embodiments, the composition includes from 2% by weight to 15% by weight of the hydrogenated styrenic block copolymer. In another embodiment, the composition includes from 2% by weight to 10% by weight of the hydrogenated styrenic block copolymer. In some embodiments, the composition includes from 2% by weight to 8% by weight of the hydrogenated styrenic block copolymer. In one embodiment, the composition includes greater than 35% by weight plasticizer. In another embodiment, the composition exhibits a Tg from 5° C. to 30° C. In other embodiments, the composition exhibits a crossover temperature of greater than 85° C. and a viscosity of no greater than 2000 cP at 121° C. in other embodiments, the composition exhibits a crossover temperature of greater than 85° C. and a viscosity of no greater than 1000 cP at 121° C. In one embodiment, the composition includes from 2% by weight to less than 15% by weight of the hydrogenated styrenic block copolymer and from 30% by weight to 60% by weight of a tackifying agent having a softening point of at least 115° C. In some embodiments, the composition includes from 2% by weight to less than 10% by weight of the hydrogenated styrenic block copolymer and from 30% by weight to 60% by weight of a tackifying agent having a softening point of at least 115° C.

In one embodiment, the plasticizer is selected from the group consisting of naphthenic oil, paraffin oil, or a combination thereof.

In another embodiment, the composition further includes a second polymer selected from the group consisting of a styrenic block copolymer having a styrene content less than 50% by weight, polyalphaolefin, and combinations thereof.

In one embodiment, the composition further includes a single-site catalyzed polyolefin. In some embodiments, the composition further includes a single-site catalyzed polyolefin selected from the group consisting of ethyleneloctene copolymer, propylene/ethylene copolymer, and combinations thereof. In one embodiment, the single-site catalyzed polyolefin is present in an amount greater than the amount of styrenic block copolymer having a styrene content greater than 55% by weight.

In another aspect the invention features a hot melt adhesive composition that includes from 2% by weight to 8% by weight of a styrenic block copolymer that includes greater than 55% by weight styrene, from 35% by weight to 50% by weight plasticizer, and from 30% by weight to 60% by weight of a tackifying agent having a softening point of at least 120° C., the composition exhibiting a crossover temperature of greater than 85° C., a viscosity of no greater than 5000 cP at 135° C., and a Tg of at least 5° C. In one embodiment, the composition exhibits a viscosity of no greater than 5000 cP at 121° C.

In other aspects the invention features a hot melt adhesive composition that includes from 2% by weight to 15% by weight of a styrenic block copolymer that includes greater than 55% by weight styrene, from 30% by weight to 50% by weight plasticizer, and from 30% by weight to 60% by weight of a tackifying agent having a softening point of at least 120° C., the composition exhibiting a crossover temperature of greater than 85° C. and a Tg of from −10° C. to 30° C. In one embodiment, the composition exhibits a storage modulus (G′) of no greater than 0.3 MPa at 25° C.

In another aspect the invention features a method of making an article where the method includes applying an adhesive composition disclosed herein on a substrate, the composition exhibiting a temperature of no greater than 110° C. and a viscosity of no greater than 5000 cP prior at the application temperature,

The present inventors have surprisingly discovered that styrenic block copolymers having a styrene content greater than 55% by weight can be successfully incorporated in a homogenous hot melt adhesive composition that is free of phase separation. The present inventors have further discovered that a relatively high plasticizer content can be successfully incorporated in the hot melt adhesive composition without causing the hot melt adhesive composition to exhibit significant bleeding of the plasticizer (i.e., staining) or excessive flow at elevated temperatures.

The present inventors also surprisingly discovered that useful low viscosity hot melt adhesive compositions could be formulated with relatively low amounts of styrenic block copolymers having a styrene content greater than 55% by weight. The present inventors have also surprisingly discovered that useful low viscosity hot melt adhesive compositions can be formulated with a combination of relatively low amounts of styrenic block copolymers having a styrene content greater than 55% by weight, relatively large amounts of plasticizer, and relatively large amounts of tackifying agent.

The present inventors also surprisingly discovered that a hot melt adhesive composition formulated with styrenic block copolymers having a styrene content greater than 55% by weight can exhibit good adhesion to temperature sensitive substrates such as polymer films and nonwoven webs. low glass transition temperatures, relatively low viscosity, and good resistance to flow at elevated temperatures as evidenced by a relatively high crossover temperature.

The present inventors have also surprisingly discovered that useful hot melt adhesive compositions formulated with less than 8% by weight of a styrenic block copolymer weight can exhibit good peel adhesion, low viscosity, and high crossover temperature.

Other features and advantages will be apparent from the following description of the preferred embodiments and from the claims.

### DETAILED DESCRIPTION

The hot melt adhesive composition includes a styrenic block copolymer that includes greater than 55 by weight styrene, plasticizer, and a tackifying agent.

Useful weight to weight ratios of the plasticizer to styrenic block copolymer in the hot melt adhesive composition include, e.g., at least 2:1, at least 4:1, at least 5:1, at least 8:1, at least 10:1, from 2:1 to 11:1, or even from 5:1 to 10:1 while maintaining adhesive properties.

The hot melt adhesive composition preferably exhibits a viscosity of no greater than 5,000 centipoise (cP), no greater than 3000 cP, or even no greater than 2000 cP at the application temperature, at 177° C., at 163° C., at 149° C., at 135° C., at 121° C., or even at 107° C. The hot melt adhesive composition also exhibits a glass transition temperature (Tg) about −20° C., at least −10° C., at least −5° C., at least 0° C., at least 5° C., at least 10° C., or at least 15° C., no greater than 35° C., no greater than 30° C., no greater than 20° C., from −10° C. to 30° C., from 5° C. to 35° C., from 10° C. to 30° C., or even from 15° C. to 30° C., when measured according to the Dynamic Mechanical Analysis (DMA) test method.

The adhesive composition preferably does not flow at 60° C. One measure of flow is crossover temperature. Crossover temperature is also a measure of cohesive strength and heat resistance. The adhesive composition preferably exhibits an upper crossover temperature (Tx) of greater than 80° C., greater than 85° C., greater than 90° C., or even greater than 92° C., when measured according to the DMA test method.

The hot melt adhesive composition also preferably exhibits minimal staining, or even is free from staining.

The hot melt adhesive composition preferably exhibits a peel adhesion of greater than 0.3 Newton per centimeter (N/cm), at least 0.4 N/cm, at least 0.5 N/cm, or even at least 0.6 N/cm when tested according to Peel Adhesion Test Method,

The hot melt adhesive composition preferably exhibits a storage modulus (i.e., G′) of less than 1.5 MPa, no greater than 1.2 MPa, no greater than 1 MPa, no greater than 0.5 MPa, no greater than 0.4 MPa, no greater than 0.3 MPa, no greater than 0.2 MPa, or even no greater than 0.1 MPa at 25° C., as determined according to the DMA test method.

The hot melt adhesive composition can be formulated to exhibit pressure sensitive adhesive or semi-pressure sensitive adhesive properties. One useful measure of pressure sensitive adhesive property is finger tack, i.e., the composition is tacky to the touch at room temperature. Another useful measure of pressure sensitive adhesive property is storage modulus (i.e., G′) as determined according to the DMA test method. When the hot melt adhesive composition is formulated to exhibit pressure sensitive adhesive properties, the hot melt adhesive composition preferably is tacky to the touch at 25° C. and exhibits a storage modulus of no greater than 0.3 MPa at 25° C. When the hot melt adhesive composition is formulated to exhibit semi-pressure sensitive adhesive properties, the hot melt adhesive composition exhibits a storage modulus from greater than 0.3 MPa to 1.0 MPa at 25° C.

### Styrenic Block Copolymer

The adhesive composition includes a high styrene content styrenic block copolymer. The term “high styrene content” ; when used in reference to a styrenic block copolymer, means a styrenic block copolymer that includes greater than 55% by weight styrene. Preferably the high styrene content styrenic block copolymer includes greater than 55% by weight, greater than 56% by weight, at least 60% by weight, or even at least 65% by weight styrene. Preferably the high styrene content styrenic block copolymer is hydrogenated and includes greater than 55% by weight % by weight, greater than 56% by weight, at least 55% by weight, at least 60% by weight, or even at least 65% by weight styrene. The high styrene content styrenic block copolymer can be in a variety of forms including, e.g., triblock, multiblock, tapered, and combinations thereof. The high styrene content styrenic block copolymer preferably is a triblock copolymer. The high styrene content styrenic block copolymer includes less than 20% diblock or even is free of diblock. The high styrene content styrenic block copolymer includes styrene end blocks (A) and at least one midblock (B).

Suitable end blocks (A) include, e.g., styrene, alpha-methylstyrene, o-methylstyrene, m-methylstyrene, p-methylstyrene, p-tent-butyl styrene, 2,4-dimethylstyrene, trimethylstyrene, and combinations thereof. Useful midblocks include, e.g., elastomeric conjugated dienes (e.g., hydrogenated and unhydrogenated conjugated dienes), sesquiterpenes (e.g., hydrogenated and nonhydrogenated sesquiterpenes), and combinations thereof.

Suitable midblocks (B) include elastometic conjugated diene blocks including, e.g., butadiene (e.g., polybutadiene), isoprene (e.g., polyisoprene), 2,3-dimethyl-1,3-butadiene, 1,3-pentadiene, 1,3-hexadiene, and combinations thereof, and hydrogenated versions thereof including, e.g., ethylene, propylene, butylene and combinations thereof (e.g., ethylene/butylene and ethylene/propylene). Suitable midblock B sesquiterpenes include, e.g., beta farnesene. Styrene optionally is present in the midblock in addition to any one or more of the aforementioned diene monomers.

Useful styrenic triblock copolymers include, e.g., styrene-butadiene-styrene, styrene-isoprene-styrene, styrene-ethylene-butylene-styrene, styrene-ethylene-propylene-styrene, styrene-ethylene-butylene-styrene-styrene, and combinations thereof. Particularly useful examples of styrenic triblock copolymers include hydrogenated styrenic block copolymers including styrene-ethylene-butylene-styrene, styrene-ethylene-propylene-styrene, and combinations thereof. The hot melt adhesive composition formulated with a hydrogenated styrenic block copolymer exhibits improved thermal stability relative to a hot melt adhesive composition formulated with a non-hydrogenated styrenic block copolymer.

Useful high styrene content styrenic triblock copolymers are commercially available under the KRATON series of trade designations from Kraton Corporation (Houston. Texas) including, e.g., KRATON MD1537 H styrene-ethylene/butylene-styrene-styrene triblock copolymer having a styrene content of 57% to 60% and a melt index of 5 g/10 min when measured according to ASTM D 1238 at 260° C. using a 5 kilogram (kg) weight and KRATON A1535 H styrene-ethylene/butylene-styrene-styrene triblock copolymer having a styrene content of 57% and a melt index of less than 1 g/10 min when measured according to ASTM D 1238 at 230° C. using a 5 kg weight, as reported by the manufacturer, under the TUFTEC series of trade designations from Asahi Kasei Corporation (Tokyo, Japan) including, e.g., TUFTEC H1043 styrene-ethylene/butylene-styrene triblock copolymer having a styrene content of 67% and a melt index of 2 g/10 min when measured according to ISO 1133 at 230° C. using a 2.16 kilogram (kg) weight, and TUFTEC P2000 a selectively hydrogenated styrene-ethylene/butylene-styrene triblock copolymer having a styrene content of 67% and a melt index of 3 g/10 min when measured according to ASTM ISO 1133 at 190 ° C. using a 2.16 kilogram (kg) weight, as reported by the manufacturer.

The adhesive composition includes at least 1.5% by weight, at least 2% by weight, at least 3% by weight, at least 4% by weight, at least 5% by weight, no greater than 25% by weight, no greater than 20% by weight, less than 15% by weight, less than 10% by weight, no greater than 8% by weight, from 1.5% by weight to 25% by weight, from 2% by weight to 25% by weight, from 3% by weight to 25% by weight, from 3% by weight to 15% by weight, from 3% by weight to 10 by weight, or even from 3% by weight to 8% by weight high styrene content styrenic block copolymer.

### Tackifying Agent

The hot melt adhesive composition includes at least one tackifying agent. Preferably the tackifying, agent has a softening point greater than 90° C., at least 100° C., at least 110° C., at least 115° C., or even at least 120° C. as determined by ASTM E28-58T. Preferred tackifying agents having a softening point greater than 90° C. have less than 10% by weight aromatic modification and include aliphatic and cycloaliphatic petroleum hydrocarbon tackifying agents, hydrogenated derivatives thereof, and combinations thereof, including, e.g., branched, unbranched, and cyclic C5 resins, C9 resins, and C10 resins, hydrogenated C9 resins, hydrogenated dicyclopentadiene (DCPD), hydrogenated C5 resins, and combinations thereof.

Other suitable classes of tackifying agents include, e.g., mixed aromatic and aliphatic modified hydrocarbon resins, aromatic modified aliphatic hydrocarbon resins, and hydrogenated versions thereof; terpenes, modified terpenes and hydrogenated versions thereof; rosin esters and hydrogenated versions thereof; and combinations thereof. The hot melt adhesive optionally is free of aromatic end-block reinforcing tackifying agents having a Tg greater than 80° C.

Examples of useful rosin esters include e.g., pentaerythritol esters of natural and modified rosins including pentaerythritol esters of pale wood rosin, pentaerythritol esters of hydrogenated rosin, pentaerythritol esters of tall oil rosin, phenolic-modified pentaerythritol esters of rosin, and combinations thereof.

Examples of useful polyterpene resins include non-hydrogenated polyterpene resins, hydrogenated polyterpene resins, and copolymers and terpolymers of natural terpenes (e.g., styrene-terpene, alpha-methyl styrene-terpene and vinyl tolueneterpene), and combinations thereof.

Useful tackifying agents are commercially available under a variety of trade designations including, e.g., the ESCOREZ series of trade designations from ExxonMobil Chemical Company (Houston, Texas) including, e.g., ESCOREZ 5637 aromatic modified, cycloaliphatic hydrocarbon resin, ESCOREZ 1310LC aliphatic hydrocarbon resin, ESCOREZ 5400 cycloaliphatic hydrocarbon resin, ESCOREZ 5415 cycloaliphatic hydrocarbon resin, ESCOREZ 5600 aromatic modified, cycloaliphatic hydrocarbon resin, ESCOREZ 5615 aromatic modified, cycloaliphatic hydrocarbon resin, and. ESCOREZ 5690 aromatic modified, cycloaliphatic hydrocarbon resin, the EASTOTAC series of trade designations from Eastman Chemical Company (Kingsport, Tennessee) including, e.g., EASTOTAC H-100R, EASTOTAC H-100L, and EASTOTAC H130W hydrogenated hydrocarbon resins, the WINGTACK series of trade designations from Cray Valley HSC (Exton, Pennsylvania) including, e.g., WINGTACK 86 aromatically modified, C-5 hydrocarbon resin, WINGTACK

EXTRA aromatically modified, C-5 hydrocarbon resin, and WINGTACK 95 aliphatic C-5 petroleum hydrocarbon resin, the PICCOTAC series of trade designations from Eastman Chemical Company (Kingsport, Tennessee) including, e.g., PICCOTAC 8095 aromatically modified, C-5 hydrocarbon resin and 1115 hydrocarbon resin, the ARKON series of trade designations from Arakawa Europe GmbH (Germany) including, e.g., ARKON P-125 alicyclic saturated hydrocarbon resin, the REGALITE and REGALREZ series of trade designations from Eastman Chemical Company including, e.g., REGALITE R1125 fully hydrogenated hydrocarbon resin and REGALREZ 1126 hydrocarbon resin, the RESINALL series of trade designations from Resinall Corp (Severn, North Carolina) including RESINALL R 1030 hydrogenated hydrocarbon resin, the SYLVALITE series of trade designations from Kraton Corporation (Savannah, Georgia) including SYLVALITE 9100 rosin ester, SYLVALITE RE 100L rosin ester (pentaerythritol ester of tall oil rosin), and SYLVALITE RE 110L rosin ester (pentaerythritol ester of tall oil rosin), and the WESTREZ series of trade designations from Ingevity Corporation (North Charleston, South Carolina) including WESTREZ 5101.

The adhesive composition includes from 30% by weight to 70% by weight, from 30% by weight to 60% by weight, from 35% by weight to 70% by weight, from 40% by weight to 70% by weight, from 45% by weight to 60% by weight, or even from 45% by weight to 55% by weight tackifying agent.

### Plasticizer

Useful plasticizers include plasticizers that are liquid at room temperature. The term “liquid” as used in reference to the plasticizer means that the plasticizer exhibits a kinematic viscosity of no greater than 5000 centistokes (cS) at 25° C. as determined according to ASTM D445 and a pour point of no greater than 30° C. as determined according to ASTM D97. Useful classes of plasticizers include, e.g., oils, and oligomeric and low molecular weight polymeric plasticizers that are liquid at room temperature. Particularly useful plasticizers include naphthenic oil, paraffinic oil (e.g., cycloparaffin oils), mineral oils, gas to liquid oils, canola oil, rapeseed oil, modified crop oil (e.g., epoxidized soybean oil), and combinations thereof When the hot melt adhesive is formulated to be suitable for use at very low application temperatures and has a viscosity less than 5000 cP, or even less than 3000 cP at 121° C., the plasticizer preferably is a naphthenic oil. When the hot melt adhesive is formulated for use in applications that require relatively low levels of aromatic volatile components, the plasticizer preferably is a paraffinic oil.

Useful plasticizers are commercially available under a variety of trade designations including, e.g., CALSOL 5550 naphthenic oil and DRAKEOL 35 paraffinic oil, from Calumet Specialty Products Partners, LP (Indianapolis, Indiana). and PURETOL 35 paraffinic oil from Petro-Canada Lubricants Inc. (Ontario, Canada), CATENEX T145 paraffinic oil from Shell Oil Products US (Houston, Texas), NYFLEX 223 naphthenic oil from Nynas AB (Stockholm, Sweden), KAYDOL mineral oil from Sonneborn (Tarrytown New York), KRYSTOL 550 mineral oil from Petrochem Carless Limited (Surrey, England), RISELLA X430 natural gas to liquid oil from Shell Oil Products US (Houston, Texas), and VIVASPES 10227 from H & R Gruppe, Klaus Dahleke GmbH & Co. KG (Germany).

The hot melt adhesive composition preferably includes at least 15% by weight, at least 20% by weight, at least 30% by weight, greater than 30% by weight, at least 33% by weight, at least 35% by weight, at least 40% by weight, no greater than 50% by weight, from 30% by weight to 50% by weight, from greater than 30% by weight to 50% by weight, from 33% by weight to 50% by weight, from 33% by weight to 45% by weight, from 35% by weight to 45% by weight, or even from 35% by weight to 42% by weight plasticizer.

### Wax

The hot melt adhesive composition optionally includes wax. Suitable waxes include non-functionalized waxes, functionalized waxes, and combinations thereof. Examples of suitable non-functionalized waxes include paraffin waxes, polyolefin waxes (e.g., polypropylene waxes and polyethylene waxes), Fischer Tropsch waxes, microcrystalline waxes, metallocene waxes, and combinations thereof.

Useful paraffin waxes are available under a variety of trade designations including, e.g., PARVAN 1580 and 1520 paraffin waxes from ExxonMobil Chemical Company (Houston, Texas) and CALUMET FR-6513 from Calumet Specialty Products Partners, LP (Indianapolis, Indiana).

Useful polyethylene waxes are commercially available under a variety of trade designations including, e.g., the EPOLENE series of trade designations from Westlake Chemical Corporation (Houston, Texas) including, e.g., EPOLENE, N-21 and N-14 polyethylene waxes, the BARECO series of trade designations from Baker Hughes Inc. (Sugar Land, Texas) including, e.g., BARECO C4040 polyethylene wax, the AC, series of trade designations from Honeywell Int'l Inc. (Morristown, New Jersey) including, e.g., A-C 8 and A-C 9 polyethylene waxes, the POLYWAX series of trade designations including POLYWAX 3000 polyethylene wax from Baker Hughes (Houston, Texas), and CWP 400 polyethylene wax from Trecora Chemical (Pasedena, Texas).

Useful polypropylene waxes are commercially available under a variety of trade designations including, e.g., EPOLENE N-15 from Westlake Chemical, HONEYWELL AC1089 from Honeywell Int'l Inc., and LICOCENE 6102 from Clariant Int'l Ltd. (Muttenz, Switzerland).

Useful Fischer Tropsch waxes are commercially available under a variety of trade designations including, e.g., the BARECO series of trade designations from Baker Hughes Inc. (Sugar Land, Texas) including, e.g., BARECO PX-100 and PX-105 Fischer Tropsch waxes, the SHELLWAX series of trade designations from Shell Malaysia Ltd. (Kuala Lumpur, Malaysia) including, e.g., SHELLWAX SX100 and SX105 Fischer Tropsch waxes, the VESTOWAX series of trade designations from Evonik Industries AG (Germany) including, e.g., VESTOWAX 2050 Fischer Tropsch wax, and the SASOLWAX series of trade designations from Sasol Wax North America Corporation (Hayward, California) including, e.g., SASOLWAX H105, C80, H1, and H4 Fischer Tropsch waxes.

Examples of suitable functionalized waxes include functionalized polypropylene wax (e.g., maleated polypropylene wax and oxidized polypropylene wax), functionalized polyethylene wax (e.g., maleated polyethylene wax and oxidized polyethylene wax), polar waxes, functionalized stearamide waxes (e.g., hydroxystearamide, N-(2-hydroxy ethyl)-12-hydroxystearamide, N,N′-ethylene bis 12-hydroxystearamide, and 12-hydroxy stearic acid. N,N′-ethylene-bis stearamide), and combinations thereof. Useful commercially available functionalized waxes include, e.g., A-C 597P, A-C 596P, and A-C 1325 maleated polypropylene waxes and A-C 573 maleated polyethylene wax all of which are available from Honeywell Int'l (Morristown, New Jersey), and EPOLENE E 43 maleated polypropylene wax available from Westlake Chemical Corporation (Houston, Texas).

The hot melt adhesive composition preferably includes less than 15% by weight, less than 10% by weight, no greater than 5% by weight, at least 1% by weight, from 0% by weight to less than 15% by weight, from 0% by weight to 10% by weight, from 0% by weight to 5% by weight, from 1% by weight to less than 15% by weight, from 1% by weight to less than 10% by weight, from 1% by weight to 5% by weight wax, or even from 1% by weight to 3% by weight wax.

### Additional Components

The hot melt adhesive composition optionally includes additional components including, e.g., tackifying agents having softening points less than 90° C., additional polymers, antioxidants, adhesion promoters, ultraviolet light stabilizers, rheology modifiers, biocides, corrosion inhibitors, dehydrators, colorants (e.g., pigments and dyes), fillers, surfactants, flame retardants, and combinations thereof.

Suitable classes of optional additional tackifying agents having softening points less than 90° C. include the classes of tackifying agent set forth above, and tackifying agents having greater than 10% by weight aromatic modification, rosin esters of glycerol, rosin esters of methanol, liquid terpene resins, and hydrogenated versions thereof. To the extent that such an optional tackifying agent is present, it is present in the adhesive composition in an amount of less than 25% by weight, less than 20 by weight, or even less than 15% by weight.

Useful classes of optional additional polymers include styrenic block copolymers other than high styrene content styrenic block copolymers, amorphous polyalphaolefins, single-site catalyzed (e.g., metallocene-catalyzed) polyolefins polypropylene, polyethylene, and copolymers of propylene, ethylene, octene, hexene, butene, and combinations thereof), amorphous polyalphaolefins, and combinations thereof.

Useful optional styrenic block copolymers include, e.g., triblock copolymers (e.g., styrene-butadiene-styrene, styrene-isoprene-styrene, styrene-ethylene-butylene-styrene, styrene-ethylene-propylene-styrene, and combinations thereof), diblock copolymers (e.g., styrene-isoprene diblock copolymers, styrene-butadiene diblock copolymers), and combinations thereof in which the styrene content in the block copolymer is less than 50% by weight, less than 45% by weight, or even less than 40% by weight. Useful commercially available styrenic block copolymers that are suitable for use as the optional additional styrenic block copolymer include, e.g., the styrenic block copolymers available under the KRATON series of trade designations from Kraton Corporation including, e.g., KRATON D 1163 SIS and 1) 1117 SIS, and KRATON G 1652 SEBS, G 1657 SEBS, G 1726 SEBS, and G 1901 SEBS, under the EUROPRENE Sol T series of trade designations from EniChem (Houston, Texas) including EURGPRENE S01, TH 2311 linear styrene-ethylenelbutylene-styrene block copolymer having a styrene content of 30% by weight, under the SEPTON series of trade designations from Septon Company of America (Pasadena, Texas) including SEPTON S 1001 SETS block copolymer and SEPTON 4030, 4033, 4044, 4055 and 4077 block copolymers, from Taiwan Synthetic Rubber Corporation (Taipei City, Taiwan) including VECTOR 4211, VECTOR 4411A, and DPX-660 styrene-isoprene-styrene block copolymers, and from Kuraray America Inc. (Houston, Texas) including, e.g., HSFC KL-SF 901 and :KL-SF 902 hydrogenated styrene-farnesene block copolymers and HYBRAR H7125 and H7311 hydrogenated SIS block copolymers.

Useful optional amorphous polyalphaolefins useful polyalphaolefins are available under the AERAFIN series of trade designations from Eastman Chemical Company including, e.g,, AERAFIN 17 and AERAFIN 180, under the VESTOPLAST series of trade designations from Evonik Industries AG (Essen, Germany) and under the REXTAC series of trade designations from Rextac LLC (Odessa, Georgia) including REXTAC 2715 butene-1 copolymer.

Useful optional single-site catalyzed polyolefins include, e.g., metallocene catalyzed polyolefins including, e.g., metallocene-catalyzed polyethylene, metallocene-catalyzed polypropylene, metallocene-catalyzed ethylene/alpha-olefin copolymers (e.g., ethylene propylene, ethylenelbutene, ethylene/hexene, and ethylene/octene copolymers, and combinations thereof), metallocene-catalyzed propylene/alpha-olefin copolymers (e.g., propylene/ethylene copolymers), and combinations thereof Useful commercially available single-site catalyzed polyolefins that are suitable for use as the optional polymer include, e.g., the metallocene-catalyzed polymers available under the EXACT and VISTAMAXA series of trade designations from ExxonMobil Chemical Company (Houston, Texas) including VISTAMAXA 8880, VISTAMAXX 8780, VISTAMAXX 8380, VISTAMAXX 6202 and VISTAMAXX 6102 metallocene catalyzed propylene/ethylene copolymers and VISTAMAXX 8816 metallocene catalyzed propylene/hexene copolymer, the single-site catalyzed polymers available under the ENGAGE and INFUSE series of trade designations from Dow Chemical Company (Midland, Michigan) including, e.g., ENGAGE 8200, ENGAGE 8400, ENGAGE 8401, and ENGAGE 8402 single-site catalyzed ethylene/octene copolymers, and INFUSE, 9500 olefin block copolymer, the metallocene catalyzed copolymers available under the SABIC series of trade designations from Sabic Innovative Plastics (Riyadh, Saudi Arabia) including, e.g., SABIC 5070 metallocene catalyzed ethylene/octene copolymer, under the AFFINITY series of trade designations from The Dow Chemical Company (Midland, Michigan) including AFFINITY GA 1900, AFFINITY 1875, and AFFINITY 1950, under the LICOCENE series of trade designations from Clariant AG Corporation (Muttenz, Switzerland) including LICOCENE PP 1502, LICOCENE PP 1602, and LICOCENE PP 2602 metallocene catalyzed polypropylenes, and under the LMODU series of trade designations from Idemitsu Kosan Co., Ltd. (Tokyo, Japan) including LMODU S400 and LMODU 5410 metallocene catalyzed polypropylenes.

The optional polymer, when present in the hot melt adhesive composition, is preferably present in an amount from at least 1% by weight, at least 5% by weight, at least 10% by weight, at least 15% by weight, no greater than 25% by weight, no greater than 23% by weight, no greater than 20% by weight, no greater than 15% by weight, no greater than 10% by weight, no greater than 8% by weight, from 2% by weight to 23% by weight, from 5% by weight to 22% by weight or even from 5% by weight to 20% by weight.

The adhesive composition preferably has a total polymer content of at least 3% by weight, at least 4% by weight, at least 5% by weight, at least 10% by weight, less than 27% by weight, no greater than 25% by weight, no greater than 20% by weight, no greater than 15% by weight, no greater than 10% by weight, from 5% by weight to 20% by weight, from 5% by weight to 15% by weight, or evenfrom 5% by weight to 10% by weight, based on the weight of the adhesive composition.

Useful antioxidants include, e.g., pentaetythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Suitable antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, New Jersey), and ETHYL 702 4,4′-methylene bis(2,6-di-tert-butylphenol). When present, the adhesive composition preferably includes from about 0.1% by weight to 2% by weight antioxidant.

### Uses

The hot melt adhesive composition is useful in a variety of forms including, e.g., as a coating (e.g., continuous coatings and discontinuous coatings (e.g., random, pattern, and array)), bead, film (e.g., a continuous films and discontinuous films), fibers, and combinations thereof.

The hot melt adhesive composition can be applied to or incorporated in a variety of substrates and articles including, e.g., woven and nonwoven webs (e.g., webs made from fibers (e.g., yarn, thread, filaments, microfibers, blown fibers, and spun fibers) and nonwoven polypropylene webs), films (e.g., polyolefin films (e.g., polypropylene and polyethylene films), nylon, rayon, polyester, polyvinyl chloride, polyurethane, and combinations thereof). perforated films, tape backings, fibers, substrates made from fibers (e.g., synthetic polymer fibers (e.g., nylon, rayon, polyesters, acrylics, polypropylenes, polyethylene, polyvinyl chloride, and polyurethane synthetic polymer fibers), virgin fibers, recycled fibers, cellulose fibers (e.g., natural cellulose fibers such as wood pulp), natural fibers (e.g., cotton, silk and wool), fibers made from natural materials including, e.g., polylactic acid, and glass fibers, and combinations thereof)), release liners, porous substrates, sheets (e.g., paper, and fiber sheets), paper products, labels (e.g., paper and polypropylene labels), substrates used in diapers, feminine hygiene (e.g., sanitary napkins), adult incontinence articles, containers (e.g., polyethylene terephthalate, polypropylene, and polyethylene), and combinations thereof.

Formulations of the hot melt adhesive composition are useful as a construction adhesive to bond polymer films (e.g., a diaper back sheet) to a nonwoven substrate, to bond two nonwoven substrates together, and combinations thereof. Such construction adhesive compositions are formulated as described above and preferably have a glass transition (Tg) temperature of from 0° C. to 40° C., from 0° C. to 30° C., or even from 5° C. to 25° C. One example of a useful construction adhesive composition includes no greater than 15% by weight of the high styrene content styrenic block copolymer, greater than 30% by weight of the plasticizer, a tackifying agent having a softening point of at least 110° C., and optionally no greater than 10% by weight wax.

Formulations of the hot melt adhesive composition are useful as a core adhesive to fix the location of the diaper core (e.g., fluff, superabsorbent polymer, and combinations thereof) during manufacture and use of the diaper. Such core adhesive compositions are formulated as described above and preferably have a Tg from −5° C. to 20° C. One example of a useful core adhesive composition includes from 5% by weight to 20% by weight of the high styrene content styrenic block copolymer, greater than 30% by weight of the plasticizer, and from 30% by weight to 60% by weight of the tackifying agent.

Formulations of the hot melt adhesive composition are useful as an elastic attachment adhesive to bond elastic strands to polyethylene or polypropylene films and nonwoven substrates. Such elastic attachment adhesive compositions are formulated as described above and preferably have a Tg from 10° C. to 35° C. and a viscosity of no greater than 10,000 cP at 163° C. or even at 150° C. Useful elastic attachment adhesives also exhibit good resistance to creep, or even a creep of no greater than 35%, or even no greater than 30%, as measured according to the % Creep test method. One example of a useful elastic attachment adhesive includes from 15% by weight to 25% by weight styrenic block copolymer wherein at least 2% by weight, or even from 5% by weight to 15% by weight of the elastic attachment adhesive composition is the high styrene content styrenic block copolymer, from 15% by weight to 30% by weight of the plasticizer, and from 50% by weight to 65% by weight of the tackifying agent.

Formulations of the hot melt adhesive composition are useful as a positioning adhesive to enable positioning of a feminine hygiene product such as a sanitary napkin or pantyliner on an article of clothing, which can be made from a variety of materials including, e.g., cotton, synthetic microfiber, nylon, and combinations thereof. Such positioning adhesive compositions are formulated as described above and preferably have a Tg, of at least about −20° C., at least −10° C., or even from −10° C. to 20° C., exhibit finger tack or even a storage modulus of no greater than 0.3 MPa at 25° C., and a 90 degree peel adhesion to cotton of at least 0.3 N/25 mm, at least 0.5 N/25 mm, or even greater than 1 N/25 mm when tested according to the 90 Degree Peel Adhesion Test Method. one example of a useful positioning adhesive composition that is repositionable includes from 2% by weight to 10% by weight of the high styrene content styrenic block copolymer, from 2% by weight to 15% by weight styrenic block copolymer other than the high styrene content block copolymer, greater than 30% by weight of the plasticizer, and from 30% by weight to 60% by weight of the tackifying agent.

Formulations of the hot melt adhesive composition are useful as container labeling adhesives to attach a label (e.g., a polyolefin label or a paper label) to a polyethylene terephthalate, polypropylene, or polyethylene container (e.g., a plastic bottle). Such container labeling adhesive compositions are formulated as described above and preferably have a Tg from 0° C. to 30° C. One example of a useful container labeling adhesive composition includes from 3% by weight to 10% by weight of the high styrene content styrenic block copolymer, greater than 20% by weight of the plasticizer, from 45% by weight to 70% by weight of the tackifying agent, and from 2% by weight to 15% by weight of the wax. The hot melt adhesive composition can be applied using any suitable application method including, e.g., slot coating, spraying, spray coating (e.g., spiral spray, random spraying, and random fiberization (e.g., melt blowing), foaming, extrusion (e.g., applying a bead, fine line extrusion, single screw extrusion, and twin screw extrusion), wheel application, noncontact coating, contacting coating, gravure, engraved roller, roll coating, transfer coating, screen printing, flexographic, “on demand” application methods, and combinations thereof.

In on demand hot melt application systems (which are also referred to as “tank free” and “tankless” systems), hot melt compositions are fed in a solid state (e.g., pellets), to a relatively small heating vessel (relative to traditional hot melt applications systems that include a. pot) where the hot melt composition is melted and, typically shortly thereafter, the molten liquid is applied to a substrate.

The invention will now be described by way of the following examples. All parts, ratios, percentages and amounts stated in the Examples are by weight unless otherwise specified.

### EXAMPLES

### Test Procedures

Test procedures used in the examples include the following. All ratios and. percentages are by weight unless otherwise indicated. The procedures are conducted at room temperature (i.e., an ambient temperature of from about 20° C. to about 23° C.) unless otherwise specified.

### Softening Point Test Method

Softening point is determined according to .ASTM 28-581.

### Dynamic Mechanical Analysis (DMA) Test Method

The glass transition temperature (Tg), crossover temperature (Tx), and storage modulus are determined according to ASTM D7028. The DMA is conducted using a DHR-II instrument and “Advantage for Q Series Version” software or equivalent. The instrument is set to DMA strain-controlled mode and temperature sweep.

The sample is placed in tension mode in the DMA instrument at a preload force of 0.01 N. The test sample is equilibrated at 130° C., is held at 130° C. for 5 minutes (min) and then the temperature is decreased to a final temperature of 0° C. at a temperature cooling rate of 10° C./min and a frequency of 10 radians per second (1.59 Hertz), conditioned at 0° C. for 10 minutes, and then heated to 130° C. at a rate of 3° C./min and a frequency of 10 radians per second (1.59 Hertz). The Tg is recorded as the first maximum temperature value for Tan Delta (G″/G′) during the heating cycle (i.e., the cycle from 0° C. to 130° C.). The upper crossover temperature (Tx) is recorded as the temperature value where Tan Delta (G″/G′)=1.0 during the heating cycle (i.e., the cycle from 0° C. to 130° C.). G′ is recorded as the storage modulus.

If the viscosity of the sample to be tested is less than 5000 cP at 121° C., then the above-described DMA method is modified as follows: the equilibration temperature and the first hold temperature are both 120° C. instead of 130° C., and the sample heating cycle is from 0° C. to 120° C. instead of 0° C. to 130° C.

If the sample to be tested is an elastic attachment adhesive, then the above-described DMA method is modified as follows: the equilibration temperature and the first hold temperature are both 150° C. instead of 130° C., and the sample heating cycle is from −20° C. to 150° C. instead of 0° C. to 130° C.

### Viscosity Test Method

The viscosity of the hot melt adhesive composition is determined in accordance with ASTM D-3236 entitled, “Standard Test Method for Apparent Viscosity of Hot Melt Adhesives and Coating Materials,” (Oct. 31, 1988) using a Brookfield Thermoset Viscometer Model RYDV 2+ and spindle number 27. The results are repotted in centipoise (“cP”).

### Peel Test Sample Preparation Method

A slot coating applicator, which is 3 inch (76.2 mm) wide, and a laminator are set to an application temperature of 121° C. unless otherwise specified, a nip pressure of 34.5 kilopascal (5 psi), an application weight of 6 g/m², and minimal rewind and unwind tensions so as not to stretch the web.

The hot melt adhesive composition is applied continuously at a coat weight of 6 g/m² on a polypropylene nonwoven web having a thickness of 0.1 mm and a basis weight of 15 g/m² as the nonwoven web is passed through the applicator at a speed of from 190 meters per minute (m/min) to 230 m/min with 5 mm deflection. A nonbreathable, layered polyethylene film having a thickness of 0.23 mm, traveling at the same speed as the nonwoven web, is then nipped into place against the adhesive composition and the nonwoven web to form a laminate.

### Peel Test Sample Preparation Method II

A slot coating applicator, which is 3 inch (76.2 mm) wide, and a laminator are set to an application temperature of 121° C. unless otherwise specified, a nip pressure of 34.5 kilopascal (5 psi), an application weight of 6 g/m², and minimal rewind and unwind tensions so as not to stretch the web.

The hot melt adhesive composition is applied continuously at a coat weight of 6 g/m² on a polypropylene nonwoven web having a thickness of 0.1 mm and a basis weight of 15 g/m² as the nonwoven web is passed through the applicator at a speed of from 190 meters per minute (m/min) to 230 m/min with 5 mm deflection. A breathable polyethylene film having a thickness of 0.23 mm, traveling at the same speed as the nonwoven web, is then nipped into place against the adhesive composition and the nonwoven web to form a laminate.

### Peel Adhesion Test Method

Dynamic Peel is determined according to ASTM D1876-01 entitled, “Test Method for Determining Peel Resistance of Adhesive (T-Peel Test Method),” with the exception that the test is run at 30.5 centimeters per minute (12 inches per minute) over a period of 10 seconds and 8 replicates are run. The test samples are run on an IMASS Spec-type test instrument, and the peel test is run in the machine direction. Unless otherwise specified, the test samples are prepared as described in the Peel Test Sample Preparation Method I or II. Eight test samples are prepared for each sample composition and the test samples are tested 24 hours after the test sample has been prepared. The average peel value over 10 seconds of peeling is recorded, and the results are reported in units of Newtons per centimeter (N/cm). Substrate failure (SF) indicates a peel force exceeding the strength of the substrates, i.e., a force of greater than 1 N/cm.

### Staining Test Method

Hot melt adhesive samples are poured from the melt into 2.54 cubic cm release lined molds and allowed to solidify for 24 hours. Upon solidification, the cube solids are removed from the molds and are placed on photocopy paper (e.g., Office Depot 20 lb, 92 Brightness Photocopy Paper). A portion of the test samples are conditioned at 38° C. and a portion of the test samples are conditioned at 60° C. The 60° C. test samples are inspected after 3 hours. The 38° C. test samples are inspected at 96 hours. For the 60° C. test samples, if the sample exhibits visible flow the sample result is recorded as a yes; if the sample does not exhibit any visible flow, the sample result is recorded as a no. For the 38° C. test samples, if there is no visible staining (i.e., visible oil) present on the reverse side of the paper, then the sample is recorded as a no, and if there is visible staining present on the reverse side of the paper, then the sample is recorded as a yes. If no visible oil is present on the reverse side of the paper, the sample is deemed to be free of staining.

### % Creep Test Method

Sample Preparation: The percent creep is measured on laminated specimens. The laminated specimens are prepared by coating a molten sample of the adhesive composition on three LYCRA 800 dtex strands, which have been pre-stretched to 300%, using a Nordson Allegro nozzle at a coat weight of 35 mg/strandhneter, a speed laminator rate of 290 m/min, and 6 pounds per linear inch (phi) compression at the nip rolls. The strands were then laminated between a non-woven web and a polyethylene back sheet to form a laminated specimen,

Testing: The first end of a laminated specimen is stapled to the edge of a sturdy piece of cardboard with the nonwoven web substrate facing up. The specimen is then extended to 100% of full extension being careful not to overextend the back sheet. The carboard substrate is marked where the sample is 300 mm in length. Another mark at 285 mm sample length is made on the carboard alongside the sample. The sample is allowed to relax until it reaches the 285 mm mark on the cardboard, and then the second end of the laminate specimen is stapled to the cardboard. The specimen is now secured at 95% full extension. At least five specimens are attached to the cardboard in this manner. The individual elastic strands (but not the polyethylene back sheet) of each sample are then cut, which allows the strands to move within the laminate. The resulting test specimens are then conditioned in an air circulating oven at 38° C. for 4 hours. Under these conditions, the elastic strands under stress can retreat to a certain distance. After four hours, the test specimens are removed from the oven and the polyethylene back sheet is marked in the area where the elastic strands remain bonded to the polyethylene back sheet. The bonded area is visually observable by observing the gathered portion of the attachment. The length of the bonded area after four hours is measured (fL). The average bond length of five samples is recorded. The ratio of the change in length (i.e., initial length (iL)−final length (iL)) to the initial length (iL), expressed in percentage (%) (i.e., [iL−fL)/iL]*100), is calculated and recorded as % creep.

### 90 Degree Peel Adhesion Test Method

The 90 degree peel adhesion of an adhesive composition is determined using a laminate prepared by coating the composition onto a silicone coated release paper in a 2.54 cm wide pattern at an add-on weight of 20 grams per square meter (g/m²) (+/−3 g/m²) using a slot applicator and then contacting the coated adhesive with the treated side of a 0.025 mm thick polyethylene film to form a silicone coated release paper/adhesive/polyethylene film laminate. Test samples having a length of 4 inches (in) (10.16 cm) in the machine direction and 1.5 in (3.81 cm) in the cross-machine direction are then cut from the laminate such that the adhesive pattern is centered in the cross-machine direction of the test sample.

The grid work of the stitching of a 124 g/m² bleached t-shirt cotton fabric (Testfabrics, Inc., West Pittston, Pennsylvania) is examined. When the cotton fabric is stretched, the sample will exhibit greater elongation in one direction than in another direction. The fabric is cut into strips having a length of 10,16 cm in the machine direction and a width of 3.81 cm in the cross-machine direction. The cotton fabric is cut lengthwise in the direction that has less elongation. All cotton fabric strips are cut as straight as possible along the stitching grid work. If the cotton fabric strips are cut askew, an inconsistent elongation of the cotton fabric test sample will result.

The release film from the test sample is removed from the adhesive and the adhesive side of each test sample is gently placed on the surface of the cotton fabric strip such that the cotton curls up (in the lengthwise direction) toward the adhesive bond to form the composite test sample. In preparing the composite test sample, the adhesive is not pressed down onto the cotton fabric. At least five test samples are prepared.

Each test sample is placed on a 2-kg mechanical roll-down device and the roller is allowed to pass over the film side of the sample two times, once in the forward direction and once in the backward direction, at a rate of 305 mm/min. A timer is then activated and the sample is placed into the jaws of IINISTRON-type peel tester. The polyethylene film is placed into the moving jaw, and the fabric is attached to the stationary jaw. Within one minute after the sample has been removed from the roll-down device, the sample is tested according to ASTM D1876-01 entitled, “Test Method for Determining Peel Resistance of Adhesive (T-Peel Test Method),” with the exception that the test is run at a rate of 305 mm/min, instead of 250 mm/min, over a period of ten seconds, and at least five replicates are run instead of the ten specified in ASTM D1876. The average peel force over ten seconds of peeling is recorded, and the results are reported in Newtons per 25 mm (N/25 mm).

### Time Temperature Pressure (TTP) 90 Degree Peel Adhesion Test Method

Time, temperature and pressure 90 degree peel adhesion is determined according to the 90 Degree Peel Adhesion Test Method set forth above with the exception that, after the test sample has been prepared and prior to testing, a 5 kilogram (kg) brass weight is placed on the test sample and the test sample is then conditioned in an oven at 40° C. for a period of time. After conditioning, the samples are removed from the oven and allowed to equilibrate to 25° C. before testing.

### Controls C1 and C2

Hot melt adhesive compositions of C1 and C2 were prepared by combining the components in the amounts (in % by weight) specified in Table I and heating the same to from 175° C. to 190° C. with mixing.

The hot melt adhesive compositions of CI and C2 were then tested according to the Viscosity, Staining, and DMA test methods and the results are reported in Table 1.

TABLE 1

| | C1 | C2 |
|---|---|---|
| KRATON G1650 | 5 | 0.00 |
| KRATON G1652 | 0 | 8 |
| ESCOREZ 5637 | 0 | 51.3 |
| RESINALL R1030 | 54.3 | 0 |
| CALSOL 5550 | 39 | 39 |
| EPOLENE N21 | 1.5 | 1.5 |
| Antioxidant | 0.2 | 0.2 |
| Viscosity at 121° C. (cP) | 725 | 995 |
| Tg (° C.) | 22 | 16 |
| Tx (° C.) | 72 | 60 |
| Flow/Staining at 3 hours and | yes/yes | yes/yes |
| 60° C. | | |
| Flow/Staining at 96 hours at | no/no | yes/yes |
| 38° C. | | |

KRATON G1650 = styrene-ethylene/butylene-styrene block copolymer including 29.2% styrene (Kraton Polymers U.S. LLC)
KRATON G1652 = styrene-ethylene/butylene-styrene block copolymer including 30% styrene (Kraton Polymers U.S. LLC)
ESCOREZ 5637 = aromatic modified, cycloaliphatic hydrocarbon resin softening point 129.5° C. (ExxonMobil Chemical Co., Houston, Texas)
RESINALL R1030 = hydrogenated cycloaliphatic hydrocarbon resin melting point 130° C. (Resinall Corp., Severn, North Carolina)
ECR840 = cycloaliphatic hydrocarbon resin having a softening point of 103.4° C. (ExxonMobil)
CALSOL 5550 = naphthenic oil (Calumet Specialty Products Partners, LP, Indianapolis, Indiana)
EPOLENE N21 = polyethylene wax (Westlake Chemical Corp., Houston, Texas)

### Examples 1-9

Hot melt adhesive compositions of Examples 1-9 were prepared by combining the components in the amounts (in % by weight) specified in Table 2 and heating the same to from 175° C. to 190° C. with mixing.

The hot melt adhesive compositions of Examples 1-9 were then tested according to the Viscosity, DMA, and. Peel Adhesion (using test samples prepared with a non-breathable polyethylene film) test methods. The results and the adhesive application temperature used to prepare the test samples for the Peel Adhesion test method are set forth below in Table 2.

TABLE 2

| | 1 | 2 | 3 | 4 | 5 | 6 | 7 | 8 | 9 |
|---|---|---|---|---|---|---|---|---|---|
| MD1537 H | 10 | 10 | 8 | 8 | 8 | 8 | 8 | 8 | 10 |
| ESCOREZ | 51.3 | 46.8 | 47.3 | 47.3 | 50.3 | 52.8 | 49.3 | 49.3 | 51.3 |
| 5637 | | | | | | | | | |
| CALSOL | 38.5 | 37 | 36 | 38 | 35 | 32.5 | 41 | 39 | 34.5 |
| 5550 | | | | | | | | | |
| CALUMET | 0 | 5 | 7 | 5 | 5 | 5 | 0 | 2 | 3.5 |
| FR 6513 | | | | | | | | | |
| EPOLENE | 0 | 1 | 1.5 | 1.5 | 1.5 | 1.5 | 1.5 | 1.5 | 1.5 |
| N-21 | | | | | | | | | |
| Antioxidant | 0.2 | 0.2 | 0.2 | 0.2 | 0.2 | 0.2 | 0.2 | 0.2 | 0.2 |
| Viscosity | | | | | | | | | |
| (cP) | | | | | | | | | |
| at 135° C. | 1565 | ND | ND | ND | ND | ND | ND | ND | ND |
| at 121° C. | 3650 | 4475 | ND | ND | 1600 | 2050 | 1700 | 1620 | 4038 |
| at 107° C. | ND | 30000 | 6175 | 5150 | 6900 | 8400 | 5900 | 6400 | 20150 |
| Tg (° C.) | 16 | 17 | 17 | 19 | 20 | 25 | 16 | 17 | 16 |
| Tx (° C.) | 93 | 96 | 94 | 94 | 95 | 97 | 93 | 94 | 96 |
| Peel | 0.74 | 0.72 | 0.66 SF | SF | 0.43 | ND | SF | 0.72 | 0.38 |
| Adhesion | | | 4/8 | 8/8 | | | 8/8 | | |
| (non- | | | | | | | | | |
| breathable | | | | | | | | | |
| film) (N/cm) | | | | | | | | | |
| Coating | 121 | 121 | 121 | 121 | 121 | 121 | 121 | 121 | 121 |
| Temp (° C.) | | | | | | | | | |

ND = Not Determined
MD1537 H = styrene-ethylene/butylene-styrene block copolymer including 55% styrene (Kraton Polymers U.S. LLC, Houston, Texas)
ESCOREZ 5637 = aromatic modified, cycloaliphatic hydrocarbon resin softening point 129.5° C. (ExxonMobil)
CALSOL 5550 = naphthenic oil (Calumet Specialty Products Partners, LP, Indianapolis, Indiana)
CALUMET FR 6513 = paraffin wax (Calumet Specialty Products Partners, L.P., Indianapolis, Indiana)
EPOLENE N-21 = polyethylene wax (Westlake Chemical Corp., Houston, Texas)
ANTIOXIDANT = IRGANOX 1010 hindered phenolic antioxidant (BASF Corp., Florham Park, New Jersey)
SF = Substrate Failure

### Examples 10-13

Hot melt adhesive compositions of Examples 10-13 were prepared by combining the components in the amounts (in % by weight) specified in Table 3 and heating the same to from 175° C. to 190° C. with mixing.

The hot melt adhesive compositions of Examples 10-13 were then tested according to the Viscosity, Staining, DMA, and Peel Adhesion (using test samples prepared with a breathable polyethylene film) test methods. The results and the adhesive application temperature used to prepare the test samples for the Peel Adhesion test method are set forth below in Table 3.

TABLE 3

| | 10 | 11 | 12 | 13 |
|---|---|---|---|---|
| MD1537 H | 8 | 8 | 8 | 6.5 |
| ESCOREZ 5637 | 51.3 | 53.3 | 55.3 | 53.3 |
| CALSOL 5550 | 39 | 37 | 35 | 38.5 |
| EPOLENE N-21 | 1.5 | 1.5 | 1.5 | 1.5 |
| Antioxidant | 0.2 | 0.2 | 0.2 | 0.2 |
| Viscosity | | | | |
| at 121° C. (cP) | 1875 | 2438 | 3025 | 1438 |
| at 107° C. (cP) | 6675 | 8700 | 10880 | 4050 |
| Tg (° C.) | 19 | 23 | 26 | 21 |
| Tx (° C.) | 93 | 94 | 94 | 90 |
| G′ at 25° C. | 0.92 | 0.16 | 0.29 | 0.14 |
| (M Pa) | | | | |
| Peel Adhesion | 1.04 | 0.38 | 0.31 | 1.06 |
| (breathable film) | SF 4/8 | SF 4/8 | SF 2/8 | SF 4/8 |
| (N/cm) | | | | |
| Coating Temp (° C.) | 121 | 121 | 121 | 121 |
| Flow/Staining at 3 | No/No | NT | NT | NT |
| hours and 60° C. | | | | |
| Flow/Staining at 96 | No/No | NT | NT | NT |
| hours at 38° C. | | | | |

NT = not tested

### Examples 14-21

Hot melt adhesive compositions of Examples 14-21 were prepared by combining the components in the amounts (in % by weight) specified in Table 4 and heating the same to from 175° C. to 190° C. with mixing.

The hot melt adhesive compositions of Examples 14-21 were then tested according to the Viscosity, DMA, Peel Adhesion (using test samples prepared with a non-breathable polyethylene film) and Staining test methods. The results and the adhesive application temperature used to prepare the test samples for the Peel Adhesion test method are set forth below in Table 4.

TABLE 4

| | 14 | 15 | 16 | 17 | 18 | 19 | 20 | 21 |
|---|---|---|---|---|---|---|---|---|
| MD1537 H | 0.00 | 0.00 | 0.00 | 8 | 5 | 5 | 5 | 4 |
| TUFTEC | 0.00 | 6.7 | 6 | 0.00 | 0.00 | 0.00 | 0.00 | 0.00 |
| P2000 | | | | | | | | |
| TUFTEC | 7.5 | 0.00 | 0.00 | 0.00 | 0.00 | 0.00 | 0.00 | 0.00 |
| H1043 | | | | | | | | |
| VECTOR | 0.00 | 0.00 | 0.00 | 0.00 | 0.00 | 0.00 | 0.00 | 2.5 |
| 4411A | | | | | | | | |
| CALSOL 5550 | 39.3 | 39.9 | 38 | 0.00 | 0.00 | 39 | 41 | 38 |
| KRYSTOL | 0.00 | 0.00 | 0.00 | 39 | 41 | 0.00 | 0.00 | 0.00 |
| 550 | | | | | | | | |
| ESCOREZ | 51.5 | 51.7 | 54.3 | 51.3 | 52.3 | 0.00 | 0.00 | 0.00 |
| 5637 | | | | | | | | |
| RESINALL | 0.00 | 0.00 | 0.00 | 0.00 | 0.00 | 54.3 | 52.3 | 53.8 |
| R-1030 | | | | | | | | |
| EPOLENE | 1.5 | 1.5 | 1.5 | 1.5 | 1.5 | 1.5 | 1.5 | 1.5 |
| N-21 | | | | | | | | |
| I-1010 | 0.2 | 0.2 | 0.2 | 0.2 | 0.2 | 0.2 | 0.2 | 0.2 |
| Viscosity | | | | | | | | |
| at 107° C. (cP) | 1629 | 1650 | 1425 | ND | 14205 | 2975 | 1913 | 3225 |
| at 121° C. (cP) | ND | 625 | ND | 10450 | 1338 | 865 | 700 | 905 |
| at 135° C. (cP) | ND | ND | ND | 1505 | ND | ND | ND | ND |
| Tg (° C.) | 16 | 16 | 25 | 19 | 12 | 25 | 19 | 21 |
| Tx (° C.) | 94 | 91 | 92 | 112 | 105 | 97 | 91 | 94 |
| G′ at 25° C. | 0.019 | 0.11 | 0.28 | 0.088 | 0.027 | 0.14 | 0.081 | 0.96 |
| (M Pa) | | | | | | | | |
| Peel Adhesion | NT | NT | NT | NT | NT | 0.85 | 0.41 | 0.73 |
| (non- | | | | | | | | |
| breathable | | | | | | | | |
| film) (N/cm) | | | | | | | | |
| Application | NA | NA | NA | NA | NA | 121 | 121 | 121 |
| Temperature | | | | | | | | |
| (° C.) | | | | | | | | |
| Flow/Staining | NT | NT | NT | NT | NT | No/No | NT | NT |
| at 3 hours and | | | | | | | | |
| 60° C. | | | | | | | | |
| Flow/Staining | NT | NT | NT | NT | NT | No/No | NT | NT |
| at 96 Hours at | | | | | | | | |
| 38° C. | | | | | | | | |

TUFTEC P2000 = styrene-ethylene/butylene-styrene block copolymer including 67% styrene (Asahi Kasci, Tokyo, Japan)
TUFTEC H1043 = styrene-ethylene/butylene-styrene block copolymer including 67% styrene (Asahi Kasei, Tokyo, Japan)
VECTOR 4411A = styrene-isoprene-styrene block copolymers including 44% styrene
KRYSTOL 550 = mineral oil (Petrochem Carless Limited, Surrey, England),
RESINALL R-1030 = hydrogenated cycloaliphatic hydrocarbon resin having a melting point of 130° C.
EPOLENE N-21 = polyethylene wax (Westlake Chemical Corp., Houston, Texas)

### Examples 22-34

Hot melt adhesive compositions of Examples 22-34 were prepared by combining the components in the amounts (in % by weight) specified in Tables 5 and 6 and heating the same to from 175° C. to 190° C. with mixing,

The hot melt adhesive compositions of Examples 22-34 were then tested according to the Viscosity and DMA test methods and the results are reported in Tables 5 and 6.

TABLE 5

| | 22 | 23 | 24 | 25 | 26 | 27 |
|---|---|---|---|---|---|---|
| MD1537 H | 5 | 4 | 3.7 | 4 | 3.5 | 5 |
| CALSOL 5550 | 39 | 35 | 35.7 | 0.00 | 0.00 | 0.00 |
| RESINALL | 55.8 | 0.00 | 0.00 | 0.00 | 0.00 | 55.8 |
| R-1030 | | | | | | |
| ESCOREZ 5637 | 0.00 | 59.3 | 36.5 | 0.00 | 59.8 | 0.00 |
| ESCOREZ 5400 | 0.00 | 0.00 | 22.5 | 59.3 | 0.00 | 0.00 |
| CATENEX | 0.00 | 0.00 | 0.00 | 35 | 35 | 39 |
| T145 | | | | | | |
| EPOLENE N21 | 0.00 | 1.5 | 1.4 | 1.5 | 1.5 | 0 |
| Antioxidant | 0.2 | 0.2 | 0.2 | 0.2 | 0.2 | 0.2 |
| Viscosity | | | | | | |
| at 107° C. (cP) | 2400 | 2550 | 1625 | 695 | 1060 | 3050 |
| at 121° C. (cP) | 870 | 985 | 680 | 280 | 480 | 578 |
| Tg (° C.) | 22 | 34 | 29 | 6 | 19 | 5 |
| Tx (° C.) | 88 | 87 | 81 | 96 | 96 | 96 |
| G′ at 25° C. | 0.025 | 1.1 | 0.30 | 0.017 | 0.078 | 0.039 |
| (M Pa) | | | | | | |

ESCOREZ 5400 = cycloaliphatic hydrocarbon resin having a softening point of 103.4° C. (Exxon Mobil)
CATENEX T145 = paraffinic oil (Shell Oil Products US, Houston, Texas)

TABLE 6

| | 28 | 29 | 30 | 31 | 32 | 33 | 34 |
|---|---|---|---|---|---|---|---|
| MD 1537 H | 14 | 14 | 12 | 12 | 5 | 4 | 4 |
| VECTOR | 0.00 | 0.00 | 0.00 | 0.00 | 0.00 | 2.5 | 2.5 |
| 4411A | | | | | | | |
| ESCOREZ | 38.5 | 38.5 | 42.5 | 0.00 | 0.00 | 0.00 | 0.00 |
| 5400 | | | | | | | |
| ESCOREZ | 0.00 | 0.00 | 0.00 | 42.5 | 0.00 | 0.00 | 0.00 |
| 5637 | | | | | | | |
| RESINALL | 0.00 | 0.00 | 0.00 | 0.00 | 54.4 | 52.9 | 54.4 |
| R-1030 | | | | | | | |
| PLASTOLYN | 8 | 8 | 6 | 6 | 0.00 | 0.00 | 0.00 |
| 290 | | | | | | | |
| CALSOL 5550 | 34.4 | 0.00 | 0.00 | 0.00 | 38.5 | 38 | 37 |
| CATENEX | 0.00 | 34.4 | 34.4 | 34.4 | 0.00 | 0.00 | 0.00 |
| T145 | | | | | | | |
| EPOLENE | 5 | 5 | 5 | 5 | 2 | 2.5 | 2 |
| N21 | | | | | | | |
| Antioxidant | 0.1 | 0.1 | 0.1 | 0.1 | 0.1 | 0.1 | 0.1 |
| Viscosity | | | | | | | |
| at 107° C. | ND | ND | ND | ND | 4300 | 5200 | 5413 |
| at 121° C. | 10450 | 168300 | ND | 38850 | 1100 | 1115 | 1190 |
| at 135° C. | 1505 | 16480 | ND | 6100 | ND | ND | ND |
| at 149° C. | ND | 3625 | 1663 | 1700 | ND | ND | ND |
| at 177° C. | ND | 1340 | 730 | ND | ND | ND | ND |
| Tg (° C.) | 19 | −4 | −2 | 2 | 27 | 23 | 26 |
| Tx (° C.) | 112 | 114 | 111 | 105 | 95 | 97 | 98 |
| G′ at 25° C. | 0.088 | 0.16 | 0.11 | 0.22 | 0.32 | 0.33 | 0.29 |
| (M Pa) | | | | | | | |

PLASTOLYN 290 = hydrocarbon resin having a softening point of 140° C. (Eastman Chemical Co., Kingsport, Tennessee)

### Examples 35-40

Hot melt adhesive compositions of Examples 35-40 were prepared by combining the components in the amounts (in % by weight) specified in Table 7 and heating he same to from 175° C. to 190° C. with mixing.

The hot melt adhesive compositions of Examples 35-40 were then tested according to the Viscosity and DMA test methods and the results are reported in Table 7. The samples of the hot melt adhesive compositions of Examples 35-38 were prepared according to the Peel Adhesion Test Sample Preparation Method II and then tested according to the Peel Adhesion test method. The results are reported in Table 7.

TABLE 7

| | 35 | 36 | 37 | 38 | 39 | 40 |
|---|---|---|---|---|---|---|
| MD1537 H | 5 | 4 | 8 | 6.5 | 4 | 4 |
| VECTOR 4411A | 0.00 | 2.5 | 0.00 | 0.00 | 0.00 | 0.00 |
| ENGAGE 8200 | 0.00 | 0.00 | 0.00 | 0.00 | 5 | 6 |
| RESINALL R1030 | 53.4 | 52.9 | 51.3 | 53.3 | 51.3 | 50.8 |
| CALSOL 5550 | 39 | 38 | 39 | 38.5 | 38 | 37.5 |
| EPOLENE N21 | 2.5 | 2.5 | 1.5 | 1.5 | 1.5 | 1.5 |
| IRGANOX 1010 | 0.1 | 0.1 | 0.2 | 0.2 | 0.5 | 0.5 |
| | 100 | 100 | 100 | 100 | 100 | 100 |
| Viscosity | | | | | | |
| at 107° C. (cP) | 2263 | 5200 | 10900 | 6250 | 9763 | 12,630 |
| at 121° C. (cP) | 665 | 1115 | 2000 | 1413 | 3913 | 5888 |
| Tg (° C.) | 22 | 23 | 16 | 20 | 14 | 12 |
| Tx (° C.) | 98 | 97 | 96 | 94 | 96 | 94 |
| Peel Adhesion (N/cm) | 0.71 | 0.74 | 0.71 | 0.75 | NT | NT |
| Coating Temperature | 110 | 110 | 110 | 110 | NT | NT |
| (° C.) | | | | | | |

ENGAGE 8200 = metallocene-catalyzed polyethylene/octene elastomer (The Dow Chemical Company, Midland, Michigan)

### Examples 41-43

Hot melt positioning adhesive compositions of Examples 41-43 were prepared by combining the components in the amounts (in % by weight) specified in Table 8 and heating the same to from 175° C. to 190° C. with mixing.

The hot inch adhesive positioning compositions of Examples 41-43 were then tested according to the Viscosity, DMA and 90 Degree Peel Adhesion test methods and the results are reported in Table 8.

TABLE 8

| | 41 | 42 | 43 |
|---|---|---|---|
| MD1537 H | 2 | 3 | 2 |
| VECTOR 4211 | 10 | 11 | 12 |
| ESCOREZ 5400 | 51.5 | 49.5 | 51.5 |
| CALSOL 5550 | 35 | 0 | 0 |
| CATENEX T145 | 0 | 35 | 33 |
| EPOLENE C13 | 1 | 1 | 1 |
| ZP Film | 0.25 | 0.25 | 0.25 |
| Antioxidant | 0.25 | 0.25 | 0.25 |
| Viscosity | | | |
| at 110° C. (cP) | 4663 | 12100 | 11450 |
| at 121° C. (cP) | 2050 | 2750 | 2865 |
| at 135° C. (cP) | 1043 | 1010 | 1143 |
| at 149° C. (cP) | 633 | 565 | 655 |
| Tg (° C.) | −4 | <−20* | −20 |
| Tx (° C.) | 84 | 92 | 92 |
| 90 Degree Peel Adhesion | 3.14 | 0.34 | 0.66 |
| to Cotton (N/25 mm) | | | |
| TTP 90 Degree Peel | 2.78 | 0.59 | 1.2 |
| Adhesion (N/25 mm) | | | |
| Finger Tack at 25° C. | High | Moderate | Moderate |

VECTOR 4211 = styrene-isoprene-styrene block copolymer (Taiwan Synthetic Rubber Corporation, Taipei City, Taiwan)
*The Tg of this example exceeds the minimum of the instrument's capabilities.

### Examples 44-48

Hot melt elastic attachment adhesive compositions of Examples 44-48 were prepared by combining the components in the amounts (in % by weight) specified in Table 8 and. heating the same to from 175° C. to 190° C. with mixing.

The hot melt adhesive compositions of Examples 44-48 were then tested according to the Viscosity, DMA and % Creep test methods and the results are reported in Table 9.

TABLE 9

| | 44 | 45 | 46 | 47 | 48 |
|---|---|---|---|---|---|
| MD1537 H | 17 | 20 | 15 | 5 | 5 |
| VECTOR 4211 | 0 | 0 | 0 | 18 | 18 |
| ESCOREZ 5400 | 0 | 58.75 | 0 | 58.75 | 56.75 |
| ESCOREZ 5600 | 58.75 | 0 | 59.75 | 0 | 0 |
| CALSOL 5550 | 22 | 19 | 20 | 16 | 16 |
| PLASTOLYN 290 | 0 | 0 | 3 | 0 | 3 |
| EPOLENE N21 | 1.5 | 1.5 | 1.5 | 1.5 | 1.5 |
| Antioxidant | 0.5 | 0.5 | 0.5 | 0.5 | 0.5 |
| ZP Film | 0.25 | 0.25 | 0.25 | 0.25 | 0.25 |
| Viscosity | | | | | |
| at 149° C. (cP) | 8025 | ND | 6850 | 10200 | 8300 |
| at 163° C. (cP) | ND | 9750 | ND | 5200 | 4250 |
| % Creep | 22.5 | 31.9 | 30.4 | 29.7 | 14.7 |
| Tg | 20 | 19.0 | 28 | 16 | 20 |
| Tx | 96 | 119 | 93 | 106 | 100 |

ESCOREZ 5600 = aromatic modified, cycloaliphatic hydrocarbon resin softening point 102.5° C. (ExxonMobil)

### Examples 48a-73

Hot melt adhesive compositions of Examples 48a-73 were prepared by combining the components in the amounts (in by weight) specified in Tables 10 and 11 and heating the same to from 175° C. to 190° C. with mixing.

The hot melt adhesive compositions of Examples 48a-73 were then tested according to the Viscosity and DMA test methods and the results are reported in Tables 10 and 11. Samples of the hot melt adhesive compositions of Examples 48a-73 were prepared according to the Peel Adhesion Test Sample Preparation Method 11 and then tested according to the Peel Adhesion test method. The results are reported in Tables 10 and 11.

TABLE 10

| | 48a | 49 | 50 | 51 | 52 | 53 | 54 | 55 | 56 | 57 | 58 |
|---|---|---|---|---|---|---|---|---|---|---|---|
| MD1537 H | 4 | 4 | 4 | 3.5 | 3.5 | 3 | 2 | 3 | 2 | 3 | 3 |
| VISTAMAXX | 0 | 0 | 0 | 0 | 0 | 0 | 0 | 6 | 7 | 6 | 0 |
| 6202 | | | | | | | | | | | |
| VISTAMAXX | 0 | 0 | 0 | 0 | 0 | 0 | 0 | 0 | 0 | 0 | 6 |
| 6102 | | | | | | | | | | | |
| ENGAGE | 5 | 5 | 5 | 0 | 0 | 0 | 0 | 0 | 0 | 0 | 0 |
| 8200 | | | | | | | | | | | |
| SABIC 5070 | 0 | 0 | 0 | 5.5 | 5.5 | 6 | 7 | 0 | 0 | 0 | 0 |
| CALSOL | 38 | 37 | 36 | 38 | 37 | 37 | 36.5 | 40 | 40 | 38 | 38 |
| 5550 | | | | | | | | | | | |
| RESINALL | 51.3 | 52.3 | 53.3 | 51.3 | 52.3 | 52.3 | 52.8 | 49.3 | 49.3 | 51.3 | 51.3 |
| R1030 | | | | | | | | | | | |
| EPOLENE | 1.5 | 1.5 | 1.5 | 1.5 | 1.5 | 1.5 | 1.5 | 1.5 | 1.5 | 1.5 | 1.5 |
| N21 | | | | | | | | | | | |
| Antioxidant | 0.2 | 0.2 | 0.2 | 0.2 | 0.2 | 0.2 | 0.2 | 0.2 | 0.2 | 0.2 | 0.1 |
| Viscosity | | | | | | | | | | | |
| at 135° C. (cP) | ND | ND | ND | ND | ND | ND | ND | ND | ND | ND | 4288 |
| at 121° C. (cP) | 3913 | 4163 | 4375 | 3775 | 4305 | 4525 | 4750 | 3100 | 2875 | 3285 | 9150 |
| at 107° C. (cP) | ND | ND | ND | 9125 | ND | ND | ND | ND | ND | ND | ND |
| Tg (° C.) | 14 | 17 | 19 | 17 | 19 | 20 | 21 | 14 | 16 | 19 | 19 |
| Tx (° C.) | 96 | 96 | 96 | 96 | 96 | 93 | 87 | 97 | 94 | 97 | 98 |
| Peel Adhesion | SF 8/8 | SF 8/8 | SF 8/8 | NT | SF 8/8 | 1.16 SF | NT | NT | NT | NT | 1.13 |
| (breathable | | | | | | 5/8 | | | | | |
| film) (N/cm) | | | | | | | | | | | |
| Coat Temp. | 121 | 121 | 121 | NA | 121 | 121 | NA | NA | NA | NA | 135 |
| (° C.) | | | | | | | | | | | |

SF = substrate failure
VISTAMAXX 6202 metallocene catalyzed polypropylene/polyethylene copolymer (ExxonMobil)
VISTAMAXX 6102 metallocene catalyzed propylene/ethylene copolymer (ExxonMobil)
ENGAGE 8200 single-site catalyzed ethylene/octene copolymer (Dow Chemical Company, Midland, Michigan)
SABIC 5070 metallocene catalyzed ethylene/octene copolymer (Sabic Innovative Plastics, Riyadh, Saudi Arabia)

TABLE 11

| | 59 | 60 | 61 | 62 | 63 | 64 | 65 | 66 |
|---|---|---|---|---|---|---|---|---|
| SOL TH | 0 | 0 | 0 | 9 | 9 | 9 | 9 | 9 |
| 2311 | | | | | | | | |
| G1652 | 9 | 9 | 9 | 0 | 0 | 0 | 0 | 0 |
| MD1537 | 3 | 3 | 3 | 3 | 3 | 3 | 3 | 3 |
| VIVASPES | 24.5 | 25 | 26.5 | 25 | 23.5 | 24.5 | 25 | 26.5 |
| 10227 | | | | | | | | |
| SYLVALITE | 60 | 58.5 | 57 | 60.5 | 62 | 60 | 58.5 | 57 |
| RE100L | | | | | | | | |
| SYLVALITE | 0 | 0 | 0 | 0 | 0 | 0 | 0 | 0 |
| 9100 | | | | | | | | |
| Waxes | 3 | 4 | 4 | 2 | 2 | 3 | 4 | 4 |
| Antioxidant | 0.5 | 0.5 | 0.5 | 0.5 | 0.5 | 0.5 | 0.5 | 0.5 |
| Tg | 26 | 20 | 22 | 25 | 27 | 26 | 20 | 22 |
| Tx | 84 | 92 | 91 | 72 | 72 | 84 | 92 | 91 |
| Viscosity @ | | | | | | | | |
| 121° C. (cP) | NT | NT | NT | 3940 | NT | NT | NT | 3800 |
| 135° C. (cP) | 2000 | 1955 | 1740 | NT | 2230 | 2000 | 1955 | 1740 |
| Peel | 0.19 | 0.31 | 0.25 | 0.51 | 0.71 | NT | NT | NT |
| Adhesion | | | | | | | | |
| N/cm | | | | | | | | |

| | 67 | 68 | 69 | 70 | 71 | 72 | 73 |
|---|---|---|---|---|---|---|---|
| SOL TH | 6 | 0 | 0 | 0 | 0 | 0 | 0 |
| 2311 | | | | | | | |
| G1652 | 0 | 0 | 0 | 0 | 0 | 0 | 0 |
| MD1537 | 6 | 6 | 6 | 7 | 8 | 7.41 | 9.99 |
| VIVASPES | 22.5 | 23.5 | 23.5 | 24.5 | 24.5 | 27.99 | 24.95 |
| 10227 | | | | | | | |
| SYLVALITE | 62 | 67 | 0 | 0 | 0 | 60.11 | 61.47 |
| RE100L | | | | | | | |
| SYLVALITE | 0 | 0 | 67 | 65 | 64 | 0 | 0 |
| 9100 | | | | | | | |
| Waxes | 3 | 2.7 | 2.7 | 2.7 | 2.7 | 3.1 | 2.8 |
| Antioxidant | 0.5 | 0.5 | 0.5 | 0.5 | 0.5 | 0.5 | 0.5 |
| Tg | NT | 25 | NT | NT | NT | NT | NT |
| Tx | NT | 92 | NT | NT | NT | NT | NT |
| Viscosity @ | | | | | | | |
| 121° C. (cP) | NT | 1575 | 1580 | 1120 | 2500 | 2000 | 4763 |
| 135° C. (cP) | 2710 | NT | NT | NT | NT | NT | NT |
| Peel | 0.38 | NT | 0.45 | 0.39 | 0.38 | 0.31 | 0.36 |
| Adhesion | | | | | | | |
| N/cm | | | | | | | |

SOL TH 2311 = EUROPRENE SOL TH 2311 linear styrene-ethylene/butylene-styrene block copolymer having a styrene content of 30% by weight (Versalis S.p.A., Italy)
VIVASPES 10227 = plasticizer (H & R Gruppe, Klaus Dahleke GmbH & Co. KG, Germany).
SYLVALITE RE 100L = pentaerythritol ester of tall oil rosin (Kraton Corporation, Houston, Texas)
SYLVALITE 9100 = rosin ester (Kraton Corporation)

Other embodiments are within the claims. The documents referred to herein are incorporated to the extent they do not conflict.
1. A hot melt adhesive composition comprising from 1.5% by weight to 25% by weight of a styrenic block copolymer comprising greater than 55 9/0 by weight styrene; at least 15% by weight plasticizer; and from 30% by weight to 70% by weight tackifying agent.
2. The hot melt adhesive composition of paragraph 1, wherein the composition exhibits a glass transition temperature (Tg) of at least −10° C.
3. The hot melt adhesive composition of any one of paragraphs 1-2, wherein the composition exhibits a Tg from 5° C. to 35° C.
4. The hot melt adhesive composition of any one of paragraphs 1-3, wherein the composition exhibits a crossover temperature of greater than 80° C. and a viscosity of no greater than 5000 cP at 121° C.
5. The hot melt adhesive composition of any one of paragraphs 1-3, wherein the composition exhibits a crossover temperature of greater than 80° C. and a viscosity of no greater than 2000 cP at 121° C.
6. The hot melt adhesive composition of any one of paragraphs 1-3, wherein the composition exhibits a crossover temperature of greater than 80° C. and a viscosity of no greater than 1000 cP at 121° C.
7. The hot melt adhesive composition of any one of paragraphs 1-3, wherein the composition exhibits a viscosity of no greater than 5000 cP at 121° C.
8. The hot melt adhesive composition of any one of paragraphs 1-3, wherein the composition exhibits a viscosity of no greater than 2000 cP at 121° C.
9. The hot melt adhesive composition of any one of paragraphs 1-8, wherein the composition exhibits a peel adhesion of at least 0.6 N/cm when tested according to Peel Adhesion Test Method.
10. The hot melt adhesive composition of any one of paragraphs 1-9, wherein the tackifying agent has a softening point of at least 110° C.
11. The hot melt adhesive composition of any one of paragraphs 1-9, wherein the tackifying agent has a softening point of at least 120° C.
12. The hot melt adhesive composition of any one of paragraphs 1-11, wherein the composition comprises greater than 30% by weight plasticizer,
13. The hot melt adhesive composition of any one of paragraphs 1-11, wherein the composition comprises at least 35% by weight plasticizer.
14. The hot melt adhesive composition of any one of paragraphs 1-11, wherein the composition comprises at least 40% by weight plasticizer.
15. The hot melt adhesive composition of any one of paragraphs 1-14, wherein the composition comprises from 2% by weight to 15% by weight styrenic block copolymer comprising greater than 55% by weight styrene.
16. The hot melt adhesive composition of any one of paragraphs 1-14, wherein the composition comprises from 2% by weight to 10% by weight styrenic block copolymer comprising greater than 55% by weight styrene.
17. The hot melt adhesive composition of any one of paragraphs 1-14, wherein the composition comprises from 2% by weight to 8% by weight styrenic block copolymer comprising greater than 55% by weight styrene.
18. The hot melt adhesive composition of any one of paragraphs 1-17, wherein the composition comprises from 2% by weight to 15% by weight of a styrenic block copolymer that comprises greater than 55% by weight styrene, and from 35% by weight to 50% by weight of the plasticizer, wherein the tackifying agent comprises from 30% by weight to 60% by weight, based on the weight of the hot melt adhesive composition, of a tackifying agent having a softening point of at least 120° C.
19. The hot melt adhesive composition of any one of paragraphs 1-17, wherein the composition comprises from 2% by weight to 10% by weight of a styrenic block copolymer that comprises greater than 55% by weight styrene, from 35% by weight to 50% by weight of the plasticizer, and from 30% by weight to 60% by weight of a tackifying agent having a softening point of at least 120° C.
20. The hot melt adhesive composition of any one of paragraphs 1-19, wherein the composition is free of staining.
21. The hot melt adhesive composition of any one of paragraphs 1-20, wherein the styrenic block copolymer is a hydrogenated styrenic block copolymer.
22. The hot melt adhesive composition of paragraph 21, wherein the composition comprises from 1.5% by weight to 25% by weight of the hydrogenated styrenic, block copolymer, greater than 30% by weight of the plasticizer, and from 30% by weight to 60% by weight of the tackifying agent.
23. The hot melt adhesive composition of paragraph 22, wherein the composition exhibits a crossover temperature of greater than 85° C. and a viscosity no greater than 5000 cP at 121° C.
24. The hot melt adhesive composition of any one of paragraphs 22 and 23, wherein the composition exhibits a peel adhesion of at least 0.4 N/cm when tested according to Peel Adhesion Test Method.
25. The hot melt adhesive composition of any one of paragraphs 22-24, wherein the composition is free of staining.
26. The hot melt adhesive composition of any one of paragraphs 22-25, wherein the tackifying agent has a softening point greater than 100° C.
27. The hot melt adhesive composition of any one of paragraphs 22-25, wherein the tackifying agent has a softening point of at least 115° C.
28. The hot melt adhesive composition of any one of paragraphs 22-27, wherein the composition comprises from 2% by weight to 15% by weight of the hydrogenated styrenic block copolymer.
29. The hot melt adhesive composition of any one of paragraphs 22-27, wherein the composition comprises from 3% by weight to 10% by weight of the hydrogenated styrenic block copolymer.
30. The hot melt adhesive composition of any one of paragraphs 22-27, wherein the composition comprises from 2% by weight to 8% by weight of the hydrogenated styrenic block copolymer.
31. The hot melt adhesive composition any one of paragraphs 22-30, wherein the composition comprises greater than 35% by weight plasticizer
32. The hot melt adhesive composition of any one of paragraphs 22-31, the composition exhibits a Tg from 5° C. to 30° C.
33. The hot melt adhesive composition of any one of paragraphs 22-32, wherein the composition exhibits a crossover temperature of greater than 85° C. and a viscosity of no greater than 2000 cP at 121° C.
34. The hot melt adhesive composition of any one of paragraphs 22-32, wherein the composition exhibits a crossover temperature of greater than 85° C. and a viscosity of no greater than 1000 cP at 121° C.
35. The hot melt adhesive composition of any one of paragraphs 1-34, wherein the composition comprises from 2% by weight to less than 15% by weight of the hydrogenated styrenic block copolymer and the tackifying agent comprises from 30% by weight to 60% by weight based on the weight of the hot melt adhesive composition, of a tackifying agent having a. softening point of at least 115° C.
36. The hot melt adhesive composition of any one of paragraphs 1-34, wherein the composition comprises from 2% by weight to less than 10% by weight of the hydrogenated styrenic block copolymer and the tackifying, agent comprises from 30% by weight to 60% by weight, based on the weight of the hot melt adhesive composition, of a tackifying agent having a softening point of at least 115° C.
37. The hot melt adhesive composition of any one of paragraphs 1-36, wherein the plasticizer is selected from the group consisting of naphthenic oil, paraffin oil, or a combination thereof.
38. The hot melt adhesive composition of any one of paragraphs 1-37, wherein the tackifying agent has a softening point greater than 90° C.
39. The hot melt adhesive composition of any one of paragraphs 1-38, wherein the composition exhibits a Tg, of at least −20° C.
40. The hot melt adhesive composition of any one of paragraphs 1-39, wherein the composition exhibits a Tg of at least 10° C.
41. The hot melt adhesive composition of any one of paragraphs 1-40 further comprising a second polymer selected from the group consisting of a styrenic block copolymer having a styrene content less than 50% by weight, polyalphaolefin, and combinations thereof.
42. The hot melt adhesive composition of any one of paragraphs 1-41 further comprising a single-site catalyzed polyolefin.
43. The hot melt adhesive composition of paragraph 42, wherein the single-site catalyzed polyolefin is present in an amount greater than the amount of styrenic block copolymer having a styrene content greater than 55% by weight.
44. The hot melt adhesive composition of any one of paragraphs 1-43 further comprising a single-site catalyzed polyolefin selected from the group consisting of ethylene/octene copolymer, propylene/ethylene: copolymer, and combinations thereof,
45. A hot melt adhesive composition comprising: from 2% by weight to 8% by weight of a styrenic block copolymer that comprises greater than 55% by weight styrene, from 35% by weight to 50% by weight plasticizer, and from 30% by weight to 60% by weight of a tackifying agent having a softening point of at least 120° C., the composition exhibiting a crossover temperature of greater than 85° C., a viscosity of no greater than 5000 cP at 135° C, and a Tg, of at least 5° C.
46. The hot melt adhesive composition of paragraph 45, wherein the composition exhibits a viscosity of no greater than 5000 cP at 121° C.
47. A hot melt adhesive composition comprising: from 2% by weight to 15% by weight of a styrenic block copolymer that comprises greater than 55% by weight styrene, from 30% by weight to 50% by weight plasticizer, and from 30% by weight to 60% by weight of a tackifying agent having a softening point of at least 120° C., the composition exhibiting a crossover temperature of greater than 85° C. and a Tg of from −10° C. to 30° C.
48. The hot melt adhesive composition of paragraph 47, wherein the composition exhibits a storage modulus (G′) of no greater than 0.3 MPa at 25° C.
49. The hot melt adhesive composition of any one of paragraphs 1-48, wherein the tackifying agent comprises a rosin ester tackifying agent and the plasticizer comprises a paraffin oil.
50. The hot melt adhesive composition of any one of paragraphs 1-49 comprising from 2% by weight to 25% by weight of the styrenic block copolymer comprising greater than 55% by weight styrene and wherein the tackifying agent comprises from 30% by weight to 70% by weight, based on the weight of the hot melt adhesive composition, of a tackifying agent having a softening point greater than 90° C.,
51. The hot melt adhesive composition of any one of paragraphs 1-50, wherein the percent by weight plasticizer present in the hot melt adhesive composition is greater than the percent by weight styrenic block copolymer present in the hot melt adhesive composition. 52. The hot melt adhesive composition of any one of paragraphs 1-51, wherein the composition comprises from 2% by weight to 15% by weight of the styrenic block copolymer that comprises greater than 55% by weight styrene, and greater than 30% by weight of the plasticizer.
53. The hot melt adhesive composition of any one of paragraphs 1-52, wherein the hot melt adhesive composition has a total polymer content of no greater than 15 by weight.
54. The hot melt adhesive composition of any one of paragraphs 1-53, comprising from 2% by weight to less than 15% by weight of the styrenic block copolymer that comprises greater than 55% by weight styrene.
55. The hot melt adhesive composition of any one of paragraphs 1-49, wherein the tackifying agent has a softening point of at least 90° C.
56. The hot melt adhesive composition of any one of paragraphs 1-54, wherein the tackifying agent has a softening point of at least 115° C.
57. The hot melt adhesive composition of any one of paragraphs 1-56, wherein the tackifying agent comprises from 30% by weight to 60 % by weight, based on the weight of the hot melt adhesive composition, of a tackifying agent having a softening point of at least 115° C.
58. The hot melt adhesive composition of any one of paragraphs 1-57, wherein the styrenic block copolymer has a styrene content greater than 56% by weight.
59. The hot melt adhesive composition of any one of paragraphs 1-58, wherein the styrenic block copolymer that comprises a styrene content greater than 55% by weight comprises less than 20% by weight styrenic diblock copolymer.
60. The hot melt adhesive composition of any one of paragraphs 1-59, wherein the styrenic block copolymer that comprises a styrene content greater than 55% by weight is free of styrenic diblock copolymer.
61. The hot melt adhesive composition of any one of paragraphs 50-60, wherein the styrenic block copolymer that comprises a styrene content greater than 55% by weight is a hydrogenated styrenic triblock copolymer.
62. The hot melt adhesive composition of any one of paragraphs 50-61, wherein the composition comprises a total polymer content of no greater than 15% by weight; from 2% by weight to less than 15% by weight of the styrenic block copolymer that comprises greater than 55% by weight styrene; and greater than 30% by weight of the plasticizer, wherein the tackifying agent comprises from 30% by weight to 60% by weight, based on the weight of the hot melt adhesive composition, of a tackifying agent having a softening point of at least 115° C., or even a softening point of at least 120° C., the percent by weight plasticizer present in the hot melt adhesive composition being greater than the percent by weight styrenic block copolymer present in the hot melt adhesive composition.
63. The hot melt adhesive composition of any one of paragraphs 50-61, wherein the styrenic block copolymer that comprises greater than 55% by weight styrene is a hydrogenated styrenic triblock copolymer and the composition comprises a total polymer content of no greater than 15 by weight; from 2% by weight to less than 15% by weight of the hydrogenated styrenic triblock copolymer that comprises greater than 55% by weight styrene; and greater than 20% by weight of the plasticizer, wherein the tackifying agent comprises from 30% by weight to 70% by weight, based on the weight of the hot melt adhesive composition, of a tackifying agent having a softening point greater than 90° C., and the percent by weight plasticizer present in the hot melt adhesive composition is greater than the percent by weight styrenic block copolymer present in the hot melt adhesive composition.
64. The hot melt adhesive composition of any one of paragraphs 1-63 further comprising wax.
65. The hot melt adhesive composition of any one of paragraphs 1-64, wherein the composition exhibits a crossover temperature of greater than 80° C.
66. The hot melt adhesive composition of paragraphs 1-65, wherein the composition exhibits a peel adhesion of at least 0.4 N/cm when tested according to Peel Adhesion Test Method.
67. The hot melt adhesive composition of any one of paragraphs 1-66, wherein the composition comprises from 2 by weight to 10% by weight of the styrenic block copolymer that comprises at least 55% by weight styrene, the composition further comprises from 2% by weight to 15% by weight of a styrenic block copolymer that comprises less than 50% by weight styrene, and the composition exhibits a storage modulus of no greater than 0.3 MPa.
68. The hot melt adhesive composition of paragraph 67, wherein the percent by weight plasticizer present in the hot melt adhesive composition is greater than the percent by weight styrenic block copolymer present in the hot melt adhesive composition.
69. The hot melt adhesive composition of paragraphs 67 and 68, wherein the composition comprises greater than 30% by weight of the plasticizer.
70. The hot melt adhesive composition of any one of paragraphs 1-69, wherein the composition exhibits a crossover temperature of greater than 80° C.
71. The hot melt adhesive composition of any one of paragraphs 1-70, wherein the composition has a total polymer content of no greater than 20% by weight.
72. An elastic attachment adhesive composition comprising the hot melt adhesive of any one of paragraphs 1-11, 15-21, 35-44, 48-61, 64-68, and 70-71, wherein the composition comprises from 15% by weight to less than 30% by weight of the plasticizer, the styrenic block copolymer is a hydrogenated, linear triblock copolymer, and the composition exhibits no greater than 35% creep.
73. The elastic attachment adhesive composition of paragraph 72 further comprising a second polymer selected from the group consisting of a styrenic block copolymer having a styrene content less than 50% by weight, polyalphaolefin, and combinations thereof
74. The elastic attachment adhesive composition of any one of paragraphs 72 and 73, wherein the composition exhibits a Tg from 10° C. to 35° C. and a viscosity no greater than 10,000 cP at 163 C.
75. The elastic attachment adhesive composition of any one of paragraphs 72-74, wherein the composition comprises from 2% by weight to no greater than 20% by weight of the styrenic block copolymer comprising greater than 55% by weight styrene.
76. The elastic attachment adhesive composition of any one of paragraphs 72-75, wherein the composition exhibits a Tx greater than 85° C.
77. The hot melt adhesive composition of any one of paragraphs 1-76, wherein the tackifying agent comprises a rosin ester tackifying agent.
78. A method of making an article, the method comprising: applying the adhesive composition of any one of paragraphs 1-77 on a substrate, the composition exhibiting a temperature of no greater than 110° C. and a viscosity of no greater than 5000 cP at the application temperature.
79. An article comprising: a first substrate; the hot melt adhesive composition of any one of paragraphs 1-77; and a second substrate adhered to the first substrate through the hot melt adhesive composition.

What is claimed is:

1-36. (canceled)

37. A hot melt adhesive composition comprising:
from 1.5% by weight to 25% by weight of a styrenic block copolymer comprising greater than 55% by weight styrene and being derived from styrene and at least one comonomer selected from the group consisting of conjugated dienes, sesquiterpenes, and combinations thereof;
greater than 30% by weight plasticizer; and
from 30% by weight to 70% by weight tackifying agent.

38. The hot melt adhesive composition of claim 37, wherein the percent by weight plasticizer present in the hot melt adhesive composition is greater than the percent by weight styrenic block copolymer present in the hot melt adhesive composition.

39. The hot melt adhesive composition of claim 37, wherein the composition comprises from 2% by weight to 15% by weight of the styrenic block copolymer that comprises greater than 55% by weight styrene.

40. The hot melt adhesive composition of claim 37, comprising from 2% by weight to less than 15% by weight of the styrenic block copolymer that comprises greater than 55% by weight styrene.

41. The hot melt adhesive composition of claim 37, wherein the composition comprises from 2% by weight to 10% by weight of the styrenic block copolymer that comprises greater than 55% by weight styrene.

42. The hot melt adhesive composition of claim 37, wherein the composition comprises from 2% by weight to 8% by weight of the styrenic block copolymer that comprises greater than 55% by weight styrene.

43. The hot melt adhesive composition of claim 37, wherein the tackifying agent comprises a tackifying agent having a softening point of at least 120° C.

44. The hot melt adhesive composition of claim 37 further comprising a second polymer selected from the group consisting of a styrenic block copolymer having a styrene content less than 50% by weight, polyalphaolefin, and combinations thereof

45. The hot melt adhesive composition of claim 37 further comprising a single-site catalyzed polyolefin.

46. The hot melt adhesive composition of claim 37 further comprising a single-site catalyzed polyolefin, the single-site catalyzed polyolefin being present in an amount greater than the amount of styrenic block copolymer that comprises a styrene content greater than 55% by weight.

47. The hot melt adhesive composition of claim 37, wherein the styrenic block copolymer that comprises a styrene content greater than 55% by weight comprises from 0% by weight to less than 20% by weight styrenic diblock copolymer.

48. The hot melt adhesive composition of claim 37, wherein the styrenic block copolymer that comprises a styrene content greater than 55% by weight is a hydrogenated styrenic triblock copolymer.

49. The hot melt adhesive composition of claim 37, wherein the composition exhibits a crossover temperature of greater than 80° C.

50. The hot melt adhesive composition of claim 37, wherein the composition exhibits a viscosity of no greater than 5000 cP at 121° C.

51. The hot melt adhesive composition of claim 37, wherein the tackifying agent comprises a rosin ester tackifying agent.

52. The hot melt adhesive composition of claim 37, wherein the composition comprises
a total polymer content of no greater than 15% by weight;
from 2% by weight to less than 15% by weight of the styrenic block copolymer that comprises greater than 55% by weight styrene and is derived from styrene and at least one comonomer selected from the group consisting of conjugated dienes, sesquiterpenes, and combinations thereof; and
greater than 30% by weight of the plasticizer,
wherein the tackifying agent comprises from 30% by weight to 60% by weight, based on the weight of the hot melt adhesive composition, tackifying agent having a softening point of at least 115° C.,
the percent by weight plasticizer present in the hot melt adhesive composition being greater than the percent by weight styrenic block copolymer present in the hot melt adhesive composition.

53. A hot melt adhesive composition comprising:
a total polymer content of no greater than 15% by weight;
from 2% by weight to less than 15% by weight of a hydrogenated styrenic triblock copolymer that comprises greater than 55% by weight styrene and is derived from styrene and at least one comonomer selected from the group consisting of conjugated dienes, sesquiterpenes, and combinations thereof;
greater than 20% by weight plasticizer; and
from 30% by weight to 70% by weight of a tackifying agent having a softening point greater than 90° C.,
the percent by weight plasticizer present in the hot melt adhesive composition being greater than the percent by weight styrenic block copolymer present in the hot melt adhesive composition.

54. An elastic attachment adhesive composition comprising:
from 1.5% by weight to 25% by weight of a hydrogenated styrenic triblock copolymer comprising greater than 55% by weight styrene and is derived from styrene and at least one comonomer selected from the group consisting of conjugated dienes, sesquiterpenes, and combinations thereof;
a total styrenic block copolymer content of from 15% by weight to 25% by weight;
from 15% by weight to 30% by weight plasticizer; and
from 30% by weight to 70% by weight tackifying agent,
the composition exhibiting no greater than 35% creep.

55. The hot melt adhesive composition of claim 37, comprising
from 2% by weight to 10% by weight of the styrenic block copolymer that comprises at least 55% by weight styrene; and
from 2% by weight to 15% by weight of a styrenic block copolymer that comprises less than 50% by weight styrene;
the composition exhibiting a storage modulus of less than 1.51 MPa at 25° C.

56. A method of making an article, the method comprising:
applying the adhesive composition of claim 37 on a substrate,
the composition exhibiting a temperature of no greater than 110° C. and a viscosity of no greater than 5000 cP at the application temperature.
